(19) United States
(12) Patent Application Publication
(10) Pub. No.: US 2017/0371675 A1
(43) Pub. Date: Dec. 28, 2017

(54) Iteration Synchronization Construct for Parallel Pipelines

(71) Applicant: QUALCOMM Incorporated, San Diego, CA (US)

(72) Inventors: Weiwei Chen, Mountain View, CA (US); Tushar Kumar, San Francisco, CA (US)

(21) Appl. No.: 15/191,266

(22) Filed: Jun. 23, 2016

(51) Int. Cl. G06F 9/38; G06F 9/30

(52) U.S. Cl. CPC G06F 9/3869; G06F 9/30145

(57) ABSTRACT

Embodiments include computing devices, apparatus, and methods implemented by the apparatus for implementing an iteration synchronization construct (ISC) for a parallel pipeline. The apparatus may initialize a first instance of the ISC for a first stage iteration of a first parallel stage of the parallel pipeline and a second instance of the ISC for a second stage iteration of the first parallel stage of the parallel pipeline. The apparatus may determine whether an execution control value is specified for the first stage iteration, and add a first execution control edge to the parallel pipeline after determining that an execution control value is specified for the first stage iteration. The apparatus may determine whether execution of the first stage iteration is complete and send a ready signal from the first instance of the ISC to the second instance if the ISC after determining that execution of the first stage iteration completed.

### BACKGROUND

Parallel pipeline scheduling and execution of processes or tasks is implemented in modern computing devices so that different stages of parallel pipeline schedules and different iterations of the stages of the parallel pipeline schedules can be executed in parallel. Parallel pipeline scheduling and execution can increase performance (such as increase throughput and/or reduce latency) and improve power/thermal characteristics (such as distribute the work across multiple cores or devices operating at lower frequencies). Thus, parallel pipeline scheduling and execution is often used for high performance streaming applications, such as image/video processing, computational photography, computer vision, etc.

Various execution controls are used to manage the execution of the parallel stages and iterations of the parallel pipelines. Controlling the order in which processes or tasks execute helps avoid errors in the execution, for example, by ensuring intermediate data used by a process or task is not overwritten by another process or task before the intermediate data is used. Such execution controls are particularly important for heterogeneous processor parallel pipelines, since execution speeds can vary between different processors or processor cores.

Typically, a pipeline requires a specification of a stage implementation for each pipeline stage (e.g., a software function call on a processing device, or the invocation of specialized hardware). The stage implementation is invoked to execute a single iteration of the corresponding stage. The pipeline stage implementations may be a-priori fixed or could be specified by a programmer using an application programming interface (API). In a parallel pipeline, the programmer may specify additional stage control features for a stage implementation. These stage control features impose correctness requirements on which iterations of a stage may execute concurrently with iterations of the same stage, a consecutive stage or a preceding stage.

The stage control features for parallel pipelines may require the implementation of additional, tricky execution controls in the pipeline scheduler to ensure correctness while maximizing parallel performance. The stage control features can include: degree of concurrency (DoC), which may be a number of consecutive stage iterations that can run in parallel; iteration lag, which may be a minimum number of iterations that a stage must run behind its predecessor; iteration rate, which may be a rate of iterations between two consecutive stages; and sliding window size, which may be a size of a circular buffer between stages that holds intermediate data produced by a stage and consumed by a successor stage. Execution controls are complex to implement and are used to enforce inter-dependent stage scheduling.

The implementation of execution controls can interfere with other scheduling priorities. As an example, the implementation of the execution controls could interfere with other scheduling mechanisms that implement a desired balance between throughput and latency. The complexity of implementing execution controls for the stage control features of parallel pipelines using traditional methods often limit the number of stage control features that programmers choose to incorporate. Thus, the amount of scheduling optimizations that programmers attempt to implement may be limited.

### SUMMARY

Various disclosed embodiments may include apparatuses and methods for implementing and managing operations in a parallel pipeline on a computing device. Various disclosed embodiments may include initializing a plurality of instances of an iteration synchronization construct (ISC) for a plurality of stage iterations of a parallel stage of the parallel pipeline. In some embodiments, the plurality of instances of the ISC may include a first instance of the ISC for a first stage iteration of a first parallel stage of the parallel pipeline and a second instance of the ISC for a second stage iteration of the first parallel stage of the parallel pipeline. Some embodiments may include determining whether execution of the first stage iteration is complete and sending a ready signal from the first instance of the ISC to the second instance of the ISC in response to determining that execution of the first stage iteration is complete.

In some embodiments, the plurality of instances of the ISC may include a third instance of the ISC for a third stage iteration of the first parallel stage of the parallel pipeline and a fourth instance of the ISC for a fourth stage iteration of a second parallel stage of the parallel pipeline. Some embodiments may further include relinquishing an execution control edge from at least one of the third stage iteration and the fourth stage iteration depending on the first instance of the ISC in response to determining that the first stage iteration is complete.

In some embodiments, the plurality of instances of the ISC may include a third instance of the ISC for a third stage iteration of the first parallel stage of the parallel pipeline. Some embodiments may further include determining whether an execution control value is specified for the first stage iteration and adding a first execution control edge for the third stage iteration depending on the first instance of the ISC in response to determining that an execution control value is specified for the first stage iteration.

In some embodiments, determining whether an execution control value is specified for the first stage iteration may include determining whether a degree of concurrency value is specified for the first parallel stage. In some embodiments, the third stage iteration may be a number of stage iterations lower in the first parallel stage than the first stage iteration, and the number may be derived from the degree of concurrency value.

In some embodiments, the plurality of instances of the ISC may include a third instance of the ISC for a third stage iteration of a second parallel stage of the parallel pipeline. Some embodiments may further include determining whether an execution control value is specified for the first stage iteration, and adding a first execution control edge for the third stage iteration depending on the first instance of the ISC in response to determining that an execution control value is specified for the first stage iteration.

In some embodiments, the second parallel stage may succeed the first parallel stage, and determining whether an execution control value is specified for the first stage iteration may include determining whether an iteration lag value is specified for between the first parallel stage and the second parallel stage. In some embodiments, the third stage iteration may be a number of stage iterations higher in the second parallel stage than the first stage iteration in the first parallel stage, and the number may be derived from the iteration lag value.

In some embodiments, the second parallel stage may succeed the first parallel stage, and the plurality of instances of the ISC may include a fourth instance of the ISC for a fourth stage iteration of the second parallel stage of the parallel pipeline. In some embodiments, determining whether an execution control value is specified for the first stage iteration may include determining whether an iteration rate value is specified for between the first parallel stage and the second parallel stage. In some embodiments, the third stage iteration may be in a range of stage iterations in the second parallel stage, and the range may be derived from the iteration rate value. Some embodiments may further include adding a second execution control edge to the parallel pipeline for the fourth stage iteration depending on the first instance of the ISC, in which the fourth stage iteration may be in the range of stage iterations in the second parallel stage.

In some embodiments the second parallel stage may precede the first parallel stage and determining whether an execution control value is specified for the first stage iteration may include determining whether a sliding window size value is specified for between the second parallel stage and the first parallel stage. In some embodiments the third stage iteration may be a number of stage iterations lower in the second parallel stage than the first stage iteration in the first parallel stage, and the number may be derived from the sliding window size value.

Various embodiments may include a processing device for managing operations in a parallel pipeline. The processing device may be configured to perform operations of one or more of the embodiment methods summarized above.

Various embodiments may include a processing device for managing operations in a parallel pipeline having means for performing functions of one or more of the embodiment methods summarized above.

Various embodiments may include a non-transitory processor-readable storage medium having stored thereon processor-executable instructions configured to cause a processor of a computing device to perform operations of one or more of the embodiment methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing an embodiment.

FIG. 2 is a component block diagram illustrating an example multi-core parallel platform suitable for implementing an embodiment.

FIG. 3A is a diagram illustrating an example of parallel pipeline processing with degree of concurrency control without implementing an iteration synchronization construct.

FIG. 3B is a diagram illustrating an example of parallel pipeline processing with degree of concurrency control implementing an embodiment of an iteration synchronization construct.

FIG. 4A is a diagram illustrating an example of parallel pipeline processing with iteration lag control without implementing an iteration synchronization construct.

FIG. 4B is a diagram illustrating an example of parallel pipeline processing with iteration lag control implementing an embodiment of an iteration synchronization construct.

FIG. 5A is a diagram illustrating an example of parallel pipeline processing with iteration rate control without implementing an iteration synchronization construct.

FIG. 5B is a diagram illustrating an example of parallel pipeline processing with iteration rate control implementing an embodiment of an iteration synchronization construct.

FIG. 6A is a diagram illustrating an example of parallel pipeline processing with sliding window size control without implementing an iteration synchronization construct.

FIG. 6B is a diagram illustrating an example of parallel pipeline processing with sliding window size control implementing an embodiment of an iteration synchronization construct.

FIG. 7 is a process flow diagram illustrating a method for implementing an iteration synchronization construct for parallel pipelines according to an embodiment.

FIG. 8 is a process flow diagram illustrating a method for initializing an instance of iteration synchronization construct for parallel pipelines according to an embodiment.

FIG. 9 is a process flow diagram illustrating a method for initializing an instance of iteration synchronization construct for parallel pipelines with degree of concurrency controls according to an embodiment.

FIG. 10 is a process flow diagram illustrating a method for initializing an instance of iteration synchronization construct for parallel pipelines with iteration lag controls according to an embodiment.

FIG. 11 is a process flow diagram illustrating a method for initializing an instance of iteration synchronization construct for parallel pipelines with iteration rate controls according to an embodiment.

FIG. 12 is a process flow diagram illustrating a method for initializing an instance of iteration synchronization construct for parallel pipelines with sliding window size controls according to an embodiment.

FIG. 13 is component block diagram illustrating an example mobile computing device suitable for use with the various embodiments.

FIG. 14 is component block diagram illustrating an example mobile computing device suitable for use with the various embodiments.

FIG. 15 is component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

The terms “computing device” and “mobile computing device” are used interchangeably herein to refer to any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, and a programmable processor. The term “computing device” may further refer to stationary computing devices including personal computers, desktop computers, all-in-one computers, workstations, super computers, mainframe computers, embedded computers, servers, home theater computers, and game consoles.

Various disclosed embodiments may include methods, and systems and devices implementing such methods for implementing an iteration synchronization construct (ISC) to provide simplified and efficient incorporation and implementation of the execution controls into parallel pipeline scheduling. The embodiments may include using the ISC to replace and implement simplified execution controls enforcing stage control features of a parallel pipeline, and serializing the execution of the parallel pipeline according to the execution controls while maintaining parallel execution of stages and iterations.

The ISC may be implemented to enforce the execution controls and stage control features between various stages and iterations of the parallel pipeline. The ISC may verify execution of a preceding iteration of a first stage and prevent execution of a successive iteration of a second stage until completion of the preceding iteration of the first stage. In various implementations, the second stage may be the same stage as (1) a preceding stage to the first stage, (2) a successive stage of the first stage, or (3) the first stage, depending on the stage control feature. The ISC may reduce the complexity of the execution controls from the preceding iteration of the first stage while enforcing the stage control features. This may be accomplished by reducing the number of execution controls, such as dependencies from the preceding iteration of the first stage to the successive iteration of the second stage.

Each iteration of a stage may be monitored by an instance of the ISC. For example, the preceding iteration of the first stage may be monitored by a first instance of the ISC. The successive iteration of the first stage may be monitored by a second instance of the ISC.

Instances of the ISC may depend upon a previous instance of the ISC that may monitor the preceding iteration of the same stage. For example, the second instance of the ISC may prevent execution of a successive iteration of a second stage that is dependent upon the corresponding iteration of the first stage, even when the corresponding iteration of the first stage is complete. In such situations the ISC may prevent execution of the successive iteration of the second stage until receiving a signal from the first instance of the ISC indicating completion of the preceding iteration of the first stage.

An instance of the ISC may prevent the execution of an iteration of a stage based on the execution controls enforcing the stage control features. Dependence between instances of the ISC may ensure that a successive iteration of the second stage may not start execution until both the corresponding iteration of the first stage is completed and all preceding iterations of the first stage are completed. In other words, the incorporation of the ISC instances between the first and second stage by the pipeline scheduling ensures that the iterations of the second stage start execution in a serial order, while still allowing concurrent execution of various iterations of the first and the second stage, and arbitrary execution completion order for the iterations of the first and second stages. The serial ordering property for the start of stage iterations simplifies the execution controls that will need to be added to implement the stage control features, while not limiting the ability of the parallel pipeline to execute iterations in parallel within and across stages.

A degree of concurrency (DoC) value indicates a limit on a number of parallel executions of the same stage. Limiting the DoC of a parallel stage is beneficial in many scenarios. For example, the nature of an algorithm of a stage implementation may require limiting DoC, or to limit the amount of compute, memory, or communication resources that a parallel stage may consume. Rather than implementing multiple dependency controls to multiple successive iterations of the same stage, an instance of the ISC may implement a single execution control to a successive iteration of the stage a number of iterations away equal to the DoC value.

An iteration lag value indicates that execution of iterations of a successive stage should be prevented until completion of a number of iterations of a prior stage equal to the iteration lag value. The iteration lag control feature may be beneficial in many situations, particularly when the second stage is a filter (e.g., in image processing pipelines) whose each iteration needs the computed results from multiple preceding iterations of the first stage. Rather than implementing multiple dependency controls to multiple successive iterations of the successive stage, an ISC that monitors an iteration of the first stage may implement an execution control to a preceding iteration of the second stage that precedes the monitored iteration by the iteration lag value. This execution control replaces the regular execution control where the ISC monitoring an iteration of the first stage has a dependence to the same iteration of the subsequent stage.

An iteration rate ratio indicates a number of consecutive iterations of a successive stage equal to the consequent of the ratio should be executed in response to the completion of a number of consecutive iterations of a first stage equal to the antecedent of the ratio. Rather than implementing multiple dependency controls from a number of iterations of the first stage equal to the antecedent to multiple iterations of the successive stage, the first instance of the ISC may implement a single execution control to the second instance of the ISC and multiple execution controls to respective successive iterations of the successive stage. With implementation of the ISC between stages having both iteration lag and iteration rate execution controls, the ISC may implement the iteration lag execution controls by offsetting the iteration rate execution controls between a first and a successive stage such that the offset execution controls are moved to preceding iterations of the second stage that precede the iteration of the first stage monitored by the ISC by the iteration lag value.

A sliding window size control value indicates that parallel execution of iterations of a stage should be prevented until completion of an iteration of a successive stage that is a number of iterations higher than the iterations of the stage equal to the sliding window size control value. The sliding window size control allows the introduction of circular buffers between stages to hold inter-stage data. The execution control prevents a later iteration of the stage from overwriting an entry of the circular buffer holding a result produced by an earlier iteration of the stage until the appropriate iteration of the successive stage has consumed the result from the earlier iteration of the stage. Rather than implementing one or more dependency controls from one or more iterations of the stage to a successive iteration of the preceding stage, the first instance of ISC may implement a single execution control to the second instance of the ISC and a single execution control to a successive iteration of the preceding stage.

The reduction in dependencies implemented by the instances of the ISC may improve performance by reducing the complexity of the execution of the parallel pipeline, and may improve the simplicity, composability, analyzability, and flexibility of code.

The ISC may also implement state-based execution controls, using the states of stage iterations and the execution controls in conjunction with the dependency based execution controls. The ISC may check the processing devices that are currently not utilized and check on the processing devices that the pipeline stages can be executed on. The ISC may use dependency based scheduling to setup work for high-latency processing devices and/or to determine whether multiple processing devices are available. The ISC may use state-based scheduling to execute work directly on low-latency processing devices. High-latency and low-latency may refer to an overhead of starting an execution of a stage iteration on a processing device, regardless of the processing speed of the processing device. As an example, a graphics processing unit (GPU) device often has a high-latency for launch, while a central processing unit (CPU) core may quickly launch execution of a stage iteration, even in systems in which the GPU has a higher compute capability than the CPU.

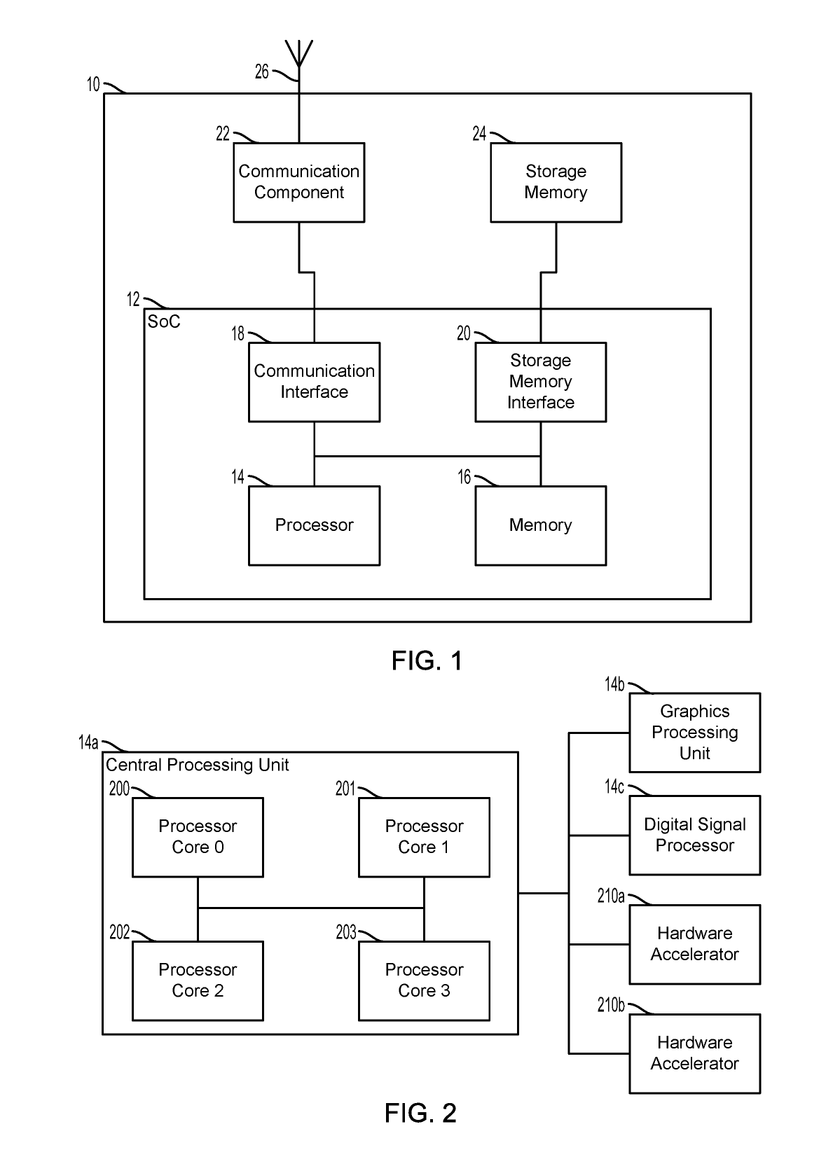

FIG. 1 illustrates a system including a computing device 10 in communication with a remote computing device suitable for use with the various embodiments. The computing device 10 may include a system-on-chip (SoC) 12 with a processor 14, a memory 16, a communication interface 18, and a storage memory interface 20. The computing device 10 may further include a communication component 22 such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. A processing device may include a variety of different types of processors 14 and processor cores, such as a general purpose processor, a central processing unit (CPU), a digital signal processor (DSP), a graphics processing unit (GPU), an accelerated processing unit (APU), an auxiliary processor, a single-core processor, and a multi-core processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processors 14. The computing device 10 may include more than one SoC 12, thereby increasing the number of processors 14 and processor cores. The computing device 10 may also include processors 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together. A group of processors 14 or processor cores may be referred to as a multi-processor cluster.

The memory 16 of the SoC 12 may be a volatile or non-volatile memory configured for storing data and processor-executable code for access by the processor 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data received from a data sensor or subsystem, data and/or processor-executable code instructions that are requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

The memory 16 may be configured to store data and processor-executable code, at least temporarily, that is loaded to the memory 16 from another memory device, such as another memory 16 or storage memory 24, for access by one or more of the processors 14. The data or processor-executable code loaded to the memory 16 may be loaded in response to execution of a function by the processor 14. Loading the data or processor-executable code to the memory 16 in response to execution of a function may result from a memory access request to the memory 16 that is unsuccessful, or a miss, because the requested data or processor-executable code is not located in the memory 16. In response to a miss, a memory access request to another memory 16 or storage memory 24 may be made to load the requested data or processor-executable code from the other memory 16 or storage memory 24 to the memory device 16. Loading the data or processor-executable code to the memory 16 in response to execution of a function may result from a memory access request to another memory 16 or storage memory 24, and the data or processor-executable code may be loaded to the memory 16 for later access.

The storage memory interface 20 and the storage memory 24 may work in unison to allow the computing device 10 to store data and processor-executable code on a non-volatile storage medium. The storage memory 24 may be configured much like an embodiment of the memory 16 in which the storage memory 24 may store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the necessary functions. Moreover, the computing device 10 may not be limited to one of each of the components, and multiple instances of each component may be included in various configurations of the computing device 10.

FIG. 2 illustrates a multi-core parallel platform suitable for implementing an embodiment. The multi-core parallel platform may include a homogenous and/or heterogeneous parallel platform. The multi-core parallel platform may include multiple processors 14a, 14b, 14c of a single type and/or various types, including, for example, a central processing unit 14a, a graphics processing unit 14b, and/or a digital processing unit 14c. Each of the processors 14a, 14b, 14c, may be single core or multi-core processor. The multi-core parallel platform may include a custom hardware accelerator 210a, 210b, which may include custom processing hardware and/or general purpose hardware (e.g., a processor 14 as described with reference to FIG. 1) configured to implement a specialized set of functions. The custom hardware accelerator 210a, 210b may be single core or multi-core processor as well.

As a multi-core processor, the processor 14a, 14b, 14c, may have a plurality of homogeneous or heterogeneous processor cores 200, 201, 202, 203. A homogeneous multi-core processor may include a plurality of homogeneous processor cores. The processor cores 200, 201, 202, 203 may be homogeneous in that, the processor cores 200, 201, 202, 203 of a single processor 14a, 14b, 14c, may be configured for the same purpose and have the same or similar performance characteristics. For example, the processor 14a may be a general purpose processor, and the processor cores 200, 201, 202, 203 may be homogeneous general purpose processor cores. The processor 14b may be a graphics processing unit and the processor 14c may be a digital signal processor, and the processor cores (not shown) of each may be homogeneous graphics processor cores or digital signal processor cores, respectively. The processor cores of the custom hardware accelerator 210a, 210b may also be homogeneous. For ease of reference, the terms “custom hardware accelerator,” “processor,” and “processor core” may be used interchangeably herein.

A heterogeneous multi-core processor may include a plurality of heterogeneous processor cores. The processor cores 200, 201, 202, 203 may be heterogeneous in that, the processor cores 200, 201, 202, 203 of a single processor 14a, 14b, 14c, and/or custom hardware accelerator 210a, 210b, may be configured for different purposes and/or have different performance characteristics. The heterogeneity of such heterogeneous processor cores may include different instruction set architecture, pipelines, operating frequencies, etc. An example of such heterogeneous processor cores may include what are known as “big.LITTLE” architectures in which slower, low-power processor cores may be coupled with more powerful and power-hungry processor cores. In similar embodiments, the SoC 12 may include a number of homogeneous or heterogeneous processors 14a, 14b, 14c, and/or custom hardware accelerator 210a, 210b. In various embodiments, not all off the processor cores 200, 201, 202, 203 need to be heterogeneous processor cores, as a heterogeneous multi-core processor may include any combination of processor cores 200, 201, 202, 203 including at least one heterogeneous processor core.

A homogeneous multi-core parallel platform may include any number of homogeneous processors of the same type. For example, a homogeneous multi-core parallel platform may include any number of one type of a homogeneous version of the central processing unit 14a, the graphics processing unit 14b, the digital processing unit 14c, or the custom hardware accelerator 210a, 210b. A heterogeneous multi-core parallel platform may include any number of processors including at least one heterogeneous processor and/or a combination of types of homogeneous processors. For example, a heterogeneous multi-core parallel platform may include at least one of a heterogeneous version of the central processing unit 14a, the graphics processing unit 14b, the digital processing unit 14c, or the custom hardware accelerator 210a, 210b. In other examples, a heterogeneous multi-core parallel platform may include a combination of homogeneous versions of the central processing unit 14a, the graphics processing unit 14b, the digital processing unit 14c, and/or the hardware accelerator 210a, 210b. In other examples, a heterogeneous multi-core parallel platform may include a combination of any number of heterogeneous and homogeneous versions of a central processing unit 14a, a graphics processing unit 14b, a digital processing unit 14c, and/or a custom hardware accelerator 210a, 210b.

In the example illustrated in FIG. 2, the multi-core processor 14a includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various embodiments to a four-core processor system. Further, reference to the four processor cores 200, 201, 202, 203 do not limit the descriptions herein to relate only to the multi-core processor 14a, and may also relate to the multi-core processors 14b, 14c. The computing device 10, the SoC 12, or the multi-core processor 14 may individually or in combination include fewer or more than the four processor cores 200, 201, 202, 203 illustrated and described herein.

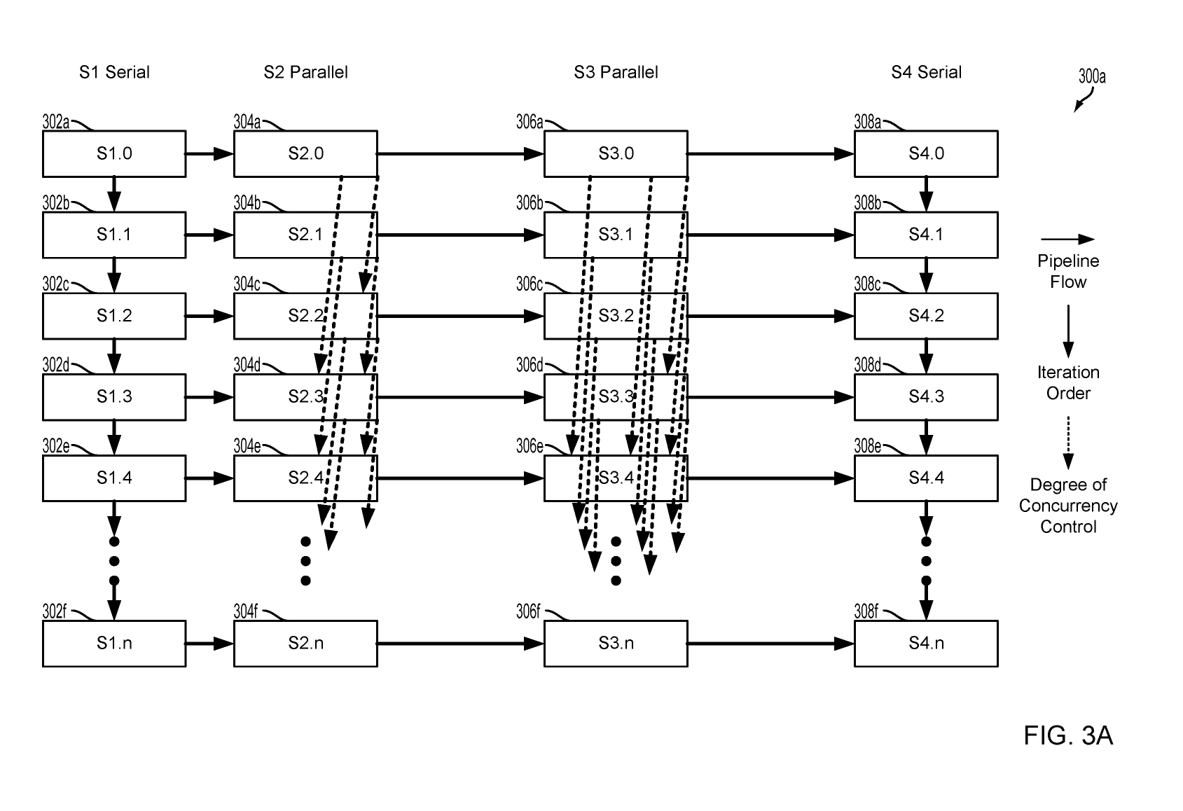

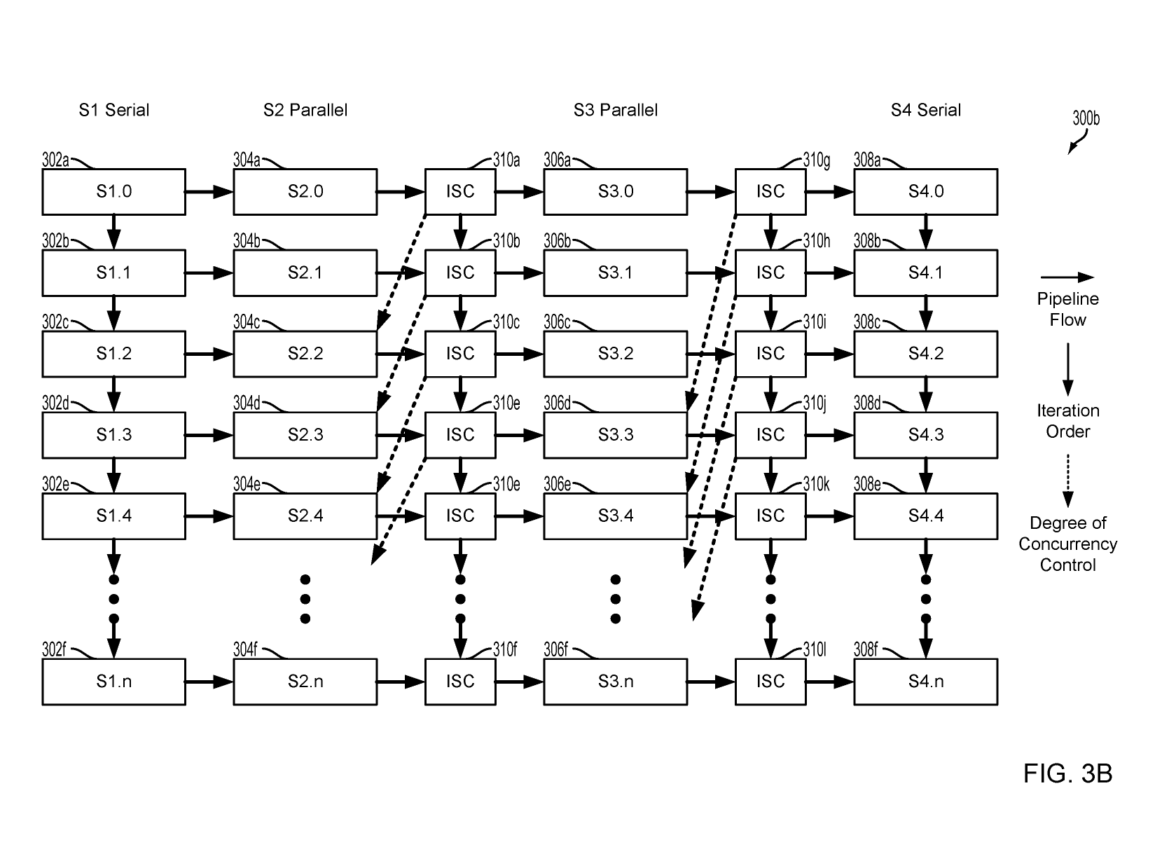

FIGS. 3A-6B illustrate non-limiting examples of parallel pipeline processing with execution controls with and without implementing an iteration synchronization construct. The examples illustrated and described herein, particularly with reference to those of and relating to FIGS. 3A-6B, are non-limiting. The parallel pipelines may include any number of parallel stages and iterations implemented with any one or more of the execution controls with or without implementation of the ISC. Each parallel pipeline and/or ISC may be implemented by one or more processing devices.

The examples illustrated in FIGS. 3A-6B may not be complete examples and may omit stages, stage iterations, and execution controls from the illustrations for the sake of simplicity, clarity, and brevity of the illustrations and the accompanying descriptions. For example, several of the stage iterations, particularly the last stage iteration prior to a gap in the illustrated stage iterations in a stage, may omit the graphical depictions of an execution control. Such omissions do not indicate that such iterations are not governed by or do not include execution controls.

As illustrated in FIGS. 3A-6B, a parallel pipeline 300a, 300b, 400a, 400b, 500a, 500b, 600a, 600b is configured to execute various serial stages (S1 and S4) and parallel stages (S2 and S3). Each serial stage includes one or more iterations 302a-302f (S1.0-S1.n), 308a-308f (S4.0-S4.n) from “0” to “n” for any positive integer value of “n”.

Serial stage iteration 302a-302f, 308a-308f may be executed in a serial manner. In other words, the serial stage iterations 302a-302f, 308a-308f of the same stage may not be executed in parallel with other serial stage iterations 302a-302f, 308a-308f the same stage. This is represented graphically in FIGS. 3A-6B by the iteration order edges connecting each of the serial stage iterations 302a-302f, 308a-308f to another of the serial stage iterations 302a-302f, 308a-308f. A serial stage iteration 302a-302f, 308a-308f connected to the base of an iteration order edge must complete before execution of the serial stage iterations 302a-302f, 308a-308f connected to the tip of the iteration order edge may begin execution.

Each parallel stage includes one or more iterations 304a-304f (S2.0-S2.n), 306a-306f (S3.0-S3.n) from “0” to “n”, for any positive integer value of “n”. Parallel stage iterations may be implemented in parallel with any other iteration 302a-302f, 304a-304f, 306a-306f, 308a-308f, unless restricted to some extent by the addition of stage control features to a stage.

FIG. 3A illustrates an example embodiment of parallel pipeline processing with degree of concurrency control without implementing an iteration synchronization construct. The parallel pipeline 300a may include parallel stage S2 with a DoC value of “2” and parallel stage S3 with a DoC value of “3”. The DoC value of “2” for parallel stage S2 indicates that two consecutive stage iterations 304a-304f can execute in parallel with each other. The DoC value of “3” for parallel stage S3 indicates that three consecutive stage iterations 306a-306f can execute in parallel with each other. In other words, stage iterations 304a-304f, 306a-306f a number of stage iterations away outside of the DoC value are prevented from executing in parallel with a first stage iteration. A DoC execution control edge extends from each parallel stage iteration 304a-304f, 306a-306f “i” of a stage “j”, Sj.i, to other parallel stage iteration 304a-304f, 306a-306f within the DoC range for the DoC value “d” within the same parallel stage S2, S3, i.e., Sj.(i+d) to Sj.(i+2d−1). The DoC execution control edges may be used to indicate the stage iterations 304a-304f, 306a-306f connected to a tip of a DoC execution control edge that are prevented from executing in parallel with a stage iteration 304a-304f, 306a-306f connected to the base of the DoC execution control edge. It may not be necessary to extend the DoC execution control edges beyond Sj.(i+2d−1) stage iterations because the cascading DoC execution controls may prevent later stage iterations 304a-304f, 306a-306f from executing prematurely.

FIG. 3B illustrates an example embodiment of parallel pipeline processing with degree of concurrency control implementing an embodiment of an iteration synchronization construct. The parallel pipeline 300b may include the same stages S1-S4, and the same stage iterations 302a-302f, 304a-304f, 306a-306f, 308a-308f, as the parallel pipeline 300a. As in the parallel pipeline 300a, the parallel pipeline 300b may include parallel stage S2 with a DoC value of “2” and parallel stage S3 with a DoC value of “3”. Rather than implementing multiple DoC execution control edges to control the stage iterations 304a-304f, 306a-306f that can execute in parallel, the parallel pipeline 300b may implement an ISC 310a-310l for each parallel stage iteration 304a-304f, 306a-306f. The ISC 310a-310l for each parallel stage iteration 304a-304f, 306a-306f may be configured to implement the same control function as the multiple DoC execution control edges. This may be accomplished by using an iteration order edge between the ISC 310a-310l of a stage iteration 304a-304f, Sj.i and the next ISC 310a-310l, Sj.(i+1), and a single DoC execution control edge from an ISC 310a-310l of a stage iteration 304a-304f, 306a-306f, Sj.i, to a stage iteration 304a-304f, 306a-306f, Sj.(i+d).

To implement execution controls, the ISC 310a-310l for each parallel stage iteration 304a-304f, 306a-306f may monitor the execution of a respective stage iteration 304a-304f, 306a-306f, wait for a ready signal from a previous ISC 310a-310l, and send a ready signal to a subsequent ISC 310a-310l. A first ISC 310a, 310g, of each parallel stage S2, S3, may not wait for a signal from another ISC 310a-310l, but may monitor the execution of its respective parallel stage iteration 304a, 306a. Any later ISC 310b-310f, 310h-310l may monitor for the ready signal from the preceding ISC 310a-310l. Each ISC 310a-310l may prevent the progression of the subsequent the ISC 310a-310l associated with the iteration order edge of the ISC 310a-310l, and prevent the execution of the stage iteration 304a-304f, 306a-306f associated with the DoC execution control edge of the ISC 310a-310l. Once the stage iteration 304a-304f, 306a-306f execution completes and/or a ready signal is received from a previous ISC 310a-310l, the ISC 310a-310l may send a ready signal to the ISC 310a-310l associated with the iteration order edge, allowing the associated ISC 310a-310l to progress when ready. The ISC 310a-310l may also relinquish the DoC execution control edge to the associated stage iteration 304a-304f, 306a-306f, allowing the associated stage iteration 304a-304f, 306a-306f to execute.

Receiving a ready signal and relinquishing of a DoC execution control edge may occur at different times for the same ISC 310a-310l since not all stage iterations 304a-304f, 306a-306f may complete execution in order. For example, the stage iterations 304a and 304b may execute in parallel. For various reasons, including available resources, processing speed, work load, etc., the stage iteration 304b may complete execution before the stage iteration 304a. The ISC 310b may observe that the stage iteration 304b has completed execution, but may maintain the DoC execution control edge because it has not yet received the ready signal from ISC 310a indicating that the stage iteration 304a has completed execution. In some embodiments, the ISC 310a-310l may require both the completion of its stage iterations 304a-304f, 306a-306f and a ready signal from the preceding ISC 310a-310l. In this manner, the ISC 310a-310l may maintain execution controls and dependencies with fewer DoC execution control edges than the number of DoC execution control edges required without the implementation of the ISC 310a-310l, as in parallel pipeline 300a.

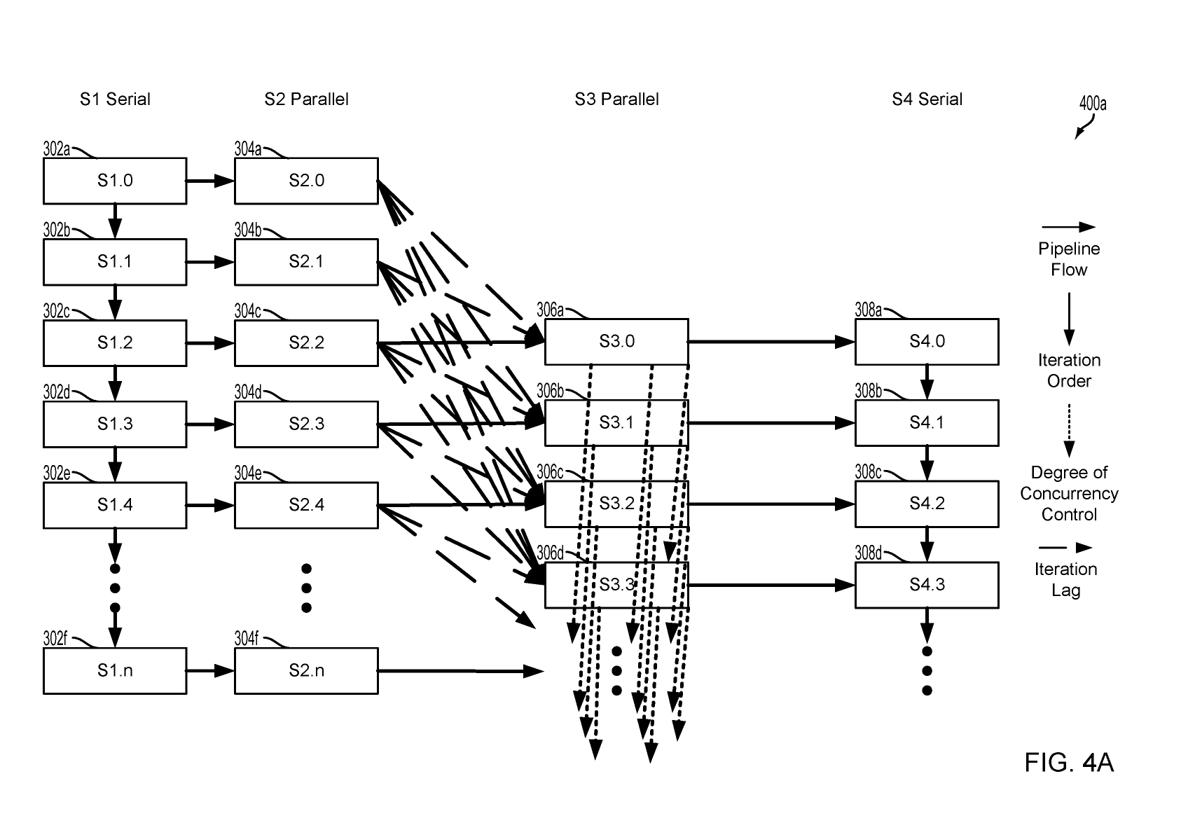

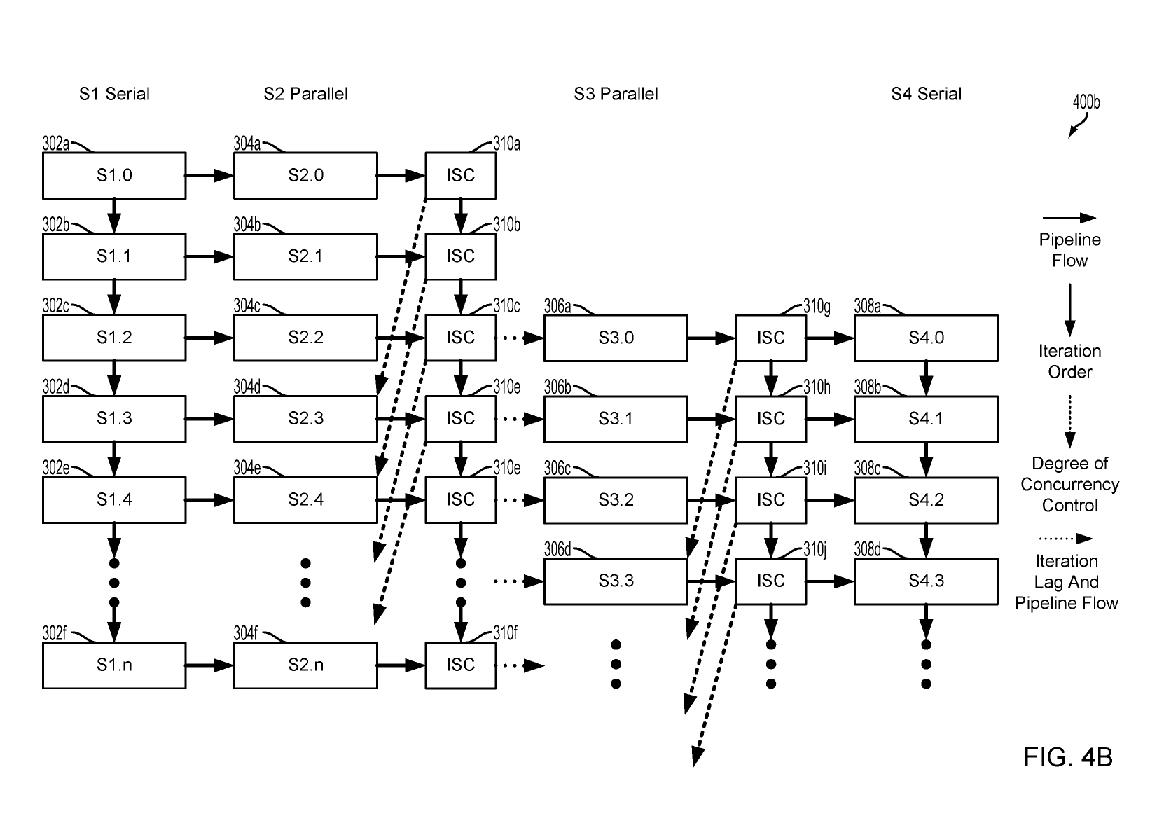

FIG. 4A illustrates an example embodiment of parallel pipeline processing with iteration lag control without implementing an iteration synchronization construct. The parallel pipeline 400a may include parallel stage S2 with a DoC value of “3” and parallel stage S3 with a DoC value of “3” and an iteration lag value of “2”. The DoC value of “3” for parallel stages S2 and S3 indicates that three stage iterations 304a-304f and 306a-306f (not all shown for the sake of clarity) can execute in parallel with each other within the same stage. A DoC execution control edge is implemented in the same manner as described with reference to FIG. 3A.

The iteration lag value of “2” for parallel stage S3 indicates that at least two stage iterations 304a-304f of the previous parallel stage S2 must execute before a stage iteration 306a-306f of parallel stage S3. In other words, an iteration lag value indicates that parallel execution of stage iterations 306a-306f of the successive stage S3 should be prevented until completion of a number of stage iterations 304a-304f of the preceding parallel stage S2 equal to the iteration lag value. An iteration lag execution control edge extends from each S2 parallel stage iteration 304a-304f “i” of a stage “j”, Sj.i, to S3 parallel stage iterations 306a-306f within the iteration lag range for the iteration lag value “1”, i.e., S(j+1).(i−1) to S(j+1).(i−1+d′−1). The DoC value “d′” of the successive stage S(j+1) is factored into the creation of iteration lag execution control edges because the DoC execution control edges of the successive stage S(j+1) can reduce the number of iteration lag execution control edges needed. The iteration lag execution control edges may be used to indicate which S3 stage iterations 306a-306f connected to a tip of an iteration lag execution control edge are prevented from executing in parallel with an S2 stage iteration 304a-304f connected to the base of the iteration lag execution control edge.

FIG. 4B illustrates an example embodiment of parallel pipeline processing with iteration lag control implementing an embodiment of an iteration synchronization construct. The parallel pipeline 400b may include the same stages S1-S4, and the same stage iterations 302a-302f, 304a-304f, 306a-306f, 308a-308f (not all shown for the sake of clarity), as the parallel pipeline 400a. As in the parallel pipeline 400a, the parallel pipeline 400b may include parallel stage S2 with a DoC value of “3” and parallel stage S3 with a DoC value of “3” and an iteration lag value of “2”. As described with reference to FIG. 3B, rather than implementing multiple DoC execution control edges to control which of the stage iterations 304a-304f, 306a-306f can execute in parallel, the parallel pipeline 400b may implement an ISC 310a-310l (not all shown for the sake of clarity) for each parallel stage iteration 304a-304f, 306a-306f.

Further, rather than implementing multiple iteration lag execution control edges to control which of the S3 stage iterations 306a-306f can execute in parallel with the S2 stage iterations 304a-304f, certain ISC 310c-310f may be configured to implement the same control function as the multiple iteration lag execution control edges. The ISC 310c-310f may use the iteration order edge between the ISC 310c-310f of a stage iteration 304c-304f, as described with reference to FIG. 3B, and a single iteration lag control edge from an ISC 310c-310f of an S2 stage iteration 304c-304f, Sj.i, to an S3 stage iteration 306a-306f, S(j+1).(i−1). As a result, the entire execution of the successive stage S3 may be shifted to begin a number of S2 stage iterations 304a-304f equal to the iteration lag value after the beginning of the preceding stage S2.

To implement execution controls, the ISC 310a-310l for each parallel stage iteration 304a-304f, 306a-306f may monitor the execution of a respective stage iteration 304a-304f, 306a-306f, wait for a ready signal from a previous ISC 310a-310l, and send a ready signal to a subsequent ISC 310a-310l, as described with reference to FIG. 3B. Each ISC 310a-310l may prevent the progression of the subsequent ISC 310a-310l associated with the iteration order edge of the ISC 310a-310l, and prevent the execution of the stage iteration 304a-304f, 306a-306f associated with the DoC execution control edge of the ISC 310a-310l. The ISC 310c-310f implementing the iteration lag execution control edge may prevent the execution of the successive S3 stage iteration 306a-306f associated with the iteration lag execution control edge of the ISC 310c-310f. Once the preceding, S2 stage iteration 304c-304f execution completes and/or a ready signal is received from a previous ISC 310a-310f, the ISC 310a-310f may send a ready signal to the ISC 310c-310f associated with the iteration order edge, allowing the associated ISC 310c-310f to progress when ready. The ISC 310c-310f may also relinquish the iteration lag control edge to the associated successive S3 stage iteration 306a-306f, allowing the associated stage iteration 306a-306f to execute.

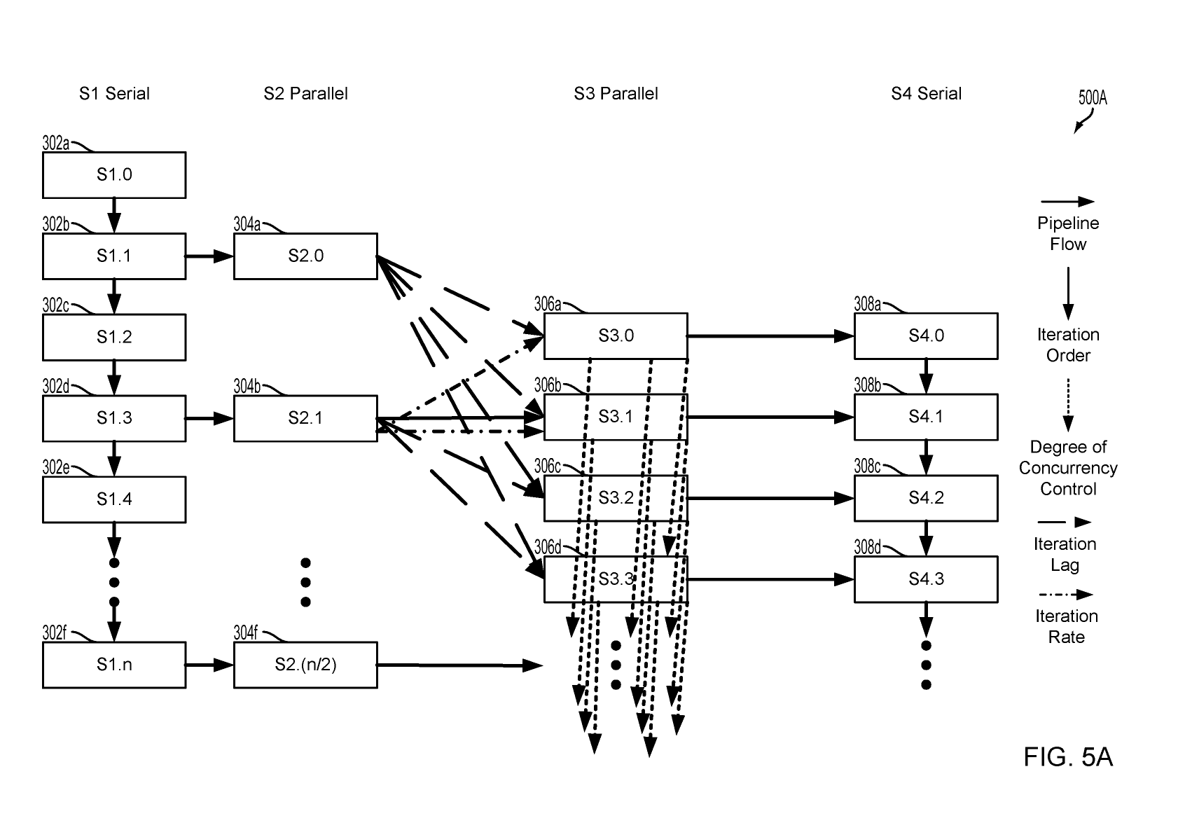

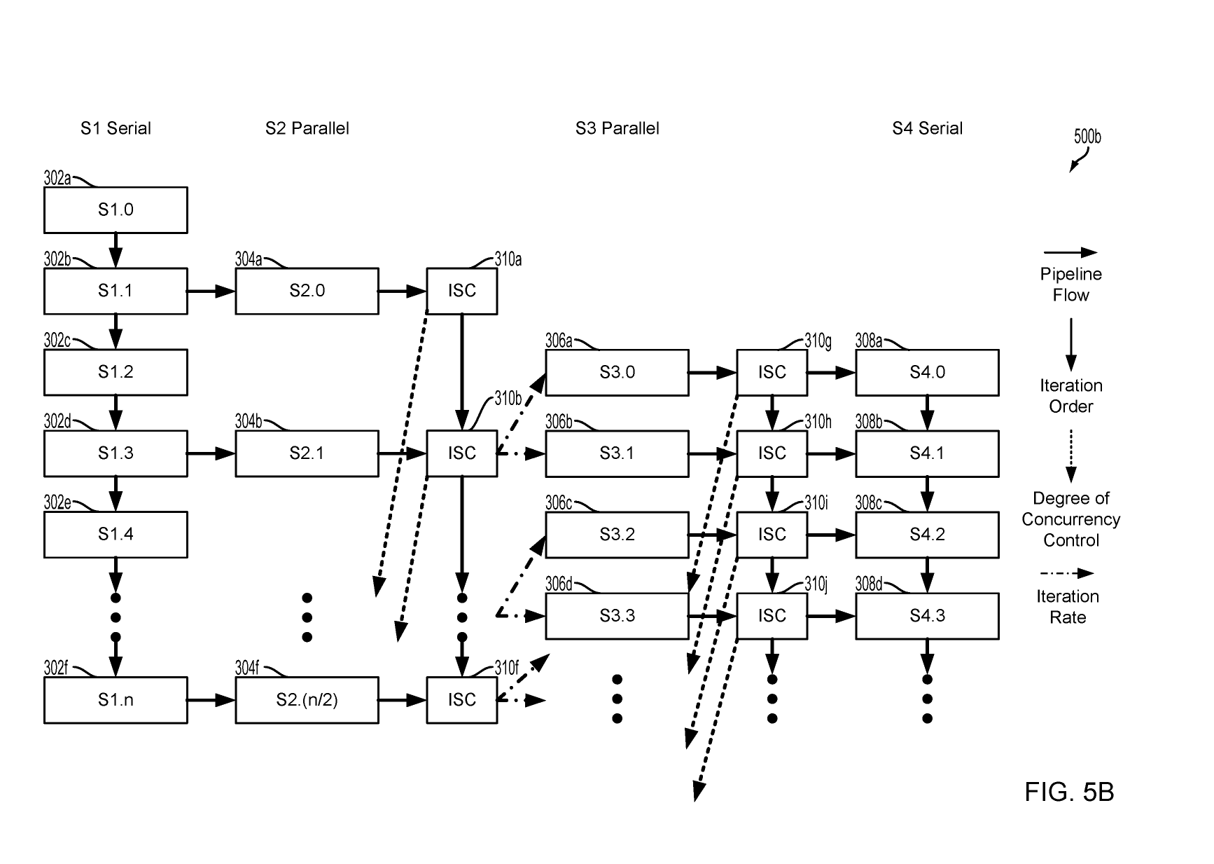

FIG. 5A illustrates an example embodiment of parallel pipeline processing with iteration rate control without implementing an iteration synchronization construct. The parallel pipeline 500a may include parallel stage S2 with a DoC value of “3” and an iteration rate value “2:1”, and parallel stage S3 with a DoC value of “3”, an iteration lag value of “1”, and an iteration rate value “1:2”. The DoC value of “3” for parallel stages S2 and S3 indicates that three stage iterations 304a-304f and 306a-306f (not all shown for the sake of clarity) can execute in parallel with each other within the same stage. A DoC execution control edge may be implemented in the same manner as described with reference to FIG. 3A. The iteration lag value of “1” for parallel stage S3 indicates that at least one stage iteration 304a-304f of the previous parallel stage S2 should execute before a stage iteration 306a-306f of parallel stage S3. An iteration lag execution control edge may be implemented in the same manner as described with reference to FIG. 4A, or by simplified means aided by the use of iteration rate execution controls.

The iteration rate value of “2:1” for parallel stage S2 indicates that for every two preceding S1 stage iterations 302a-302f, only one S2 stage iteration 304a-304f may execute. The iteration rate value of “1:2” for parallel stage S3 indicates that for that for every one preceding S2 stage iteration 304a-304f, only two S3 stage iterations 306a-306f may execute. In other words, the iteration rate value indicates that parallel execution of a number of iterations of a successive stage equal to the consequent of the ratio should be prevented until completion of a number of iterations of a stage equal to the antecedent of the ratio. An iteration rate execution control edge extends from each preceding stage iteration 302a-302f, 304a-304f, “i” of a stage “j”, Sj.i, to successive stage iterations 304a-304f, 306a-306f according to the iteration rate ratio for the iteration rate value “r2/r1” (i.e., Sj.i to S(j+1).(floor((i−1−1)*r2/r1)+1) until S(j+1).(floor((i−1)*r2/r1))). The iteration rate execution control edges may be used to indicate the S3 stage iterations 306a-306f connected to a tip of an iteration rate execution control edge that are prevented from executing in parallel with an S2 stage iteration 304a-304f connected to the base of the iteration rate execution control edge.

FIG. 5B illustrates an example embodiment of parallel pipeline processing with iteration rate control implementing an iteration synchronization construct. The parallel pipeline 500b may include the same stages S1-S4 and the same stage iterations 302a-302f, 304a-304f, 306a-306f, 308a-308f (not all shown for the sake of clarity) as the parallel pipeline 500a. As in the parallel pipeline 500a, the parallel pipeline 500b may include parallel stage S2 with a DoC value of “3” and an iteration rate value “2:1”. The parallel pipeline 500b may also include parallel stage S3 with a DoC value of “3”, an iteration lag value of “1”, and an iteration rate value “1:2”. As described with reference to FIG. 3B, rather than implementing multiple DoC execution control edges to control the stage iterations 304a-304f, 306a-306f that can execute in parallel, the parallel pipeline 500b may implement an ISC 310a-310l (not all shown for the sake of clarity) for each parallel stage iteration 304a-304f, 306a-306f.

Further, rather than implementing multiple iteration lag execution control edges to control the S3 stage iterations 306a-306f that can execute in parallel with the S2 stage iterations 304a-304f, iteration rate execution control edges can be used to implement the constraints of the iteration lag execution control and the iteration rate execution control. The number of iteration rate execution control edges may not be decreased with the implementation of the ISC 310a-310l. Certain ISCs 310b-310f may be configured to implement the same control function as the multiple iteration lag execution control edges and the iteration rate execution control edges using the iteration order edge between the ISC 310b-310f of a stage iteration 304b-304f, as described with reference to FIG. 3B, and iteration rate control edges from an ISC 310b-310f of an S2 stage iteration 304b-304f, Sj.i, to S3 stage iterations 306a-306f, S(j+1).(floor((i−1−1)*r2/r1)+1) until S(j+1).(floor((i−1)*r2/r1)). As a result, the entire execution of the successive stage S3 may be shifted to begin a number of S2 stage iterations 304a-304f equal to the iteration lag value after the beginning of the preceding stage S2. Individual executions of the successive stage S3 iterations 306a-306f may also be shifted for iteration rate values greater than “1”.

To implement execution controls, the ISC 310a-310l for each parallel stage iteration 304a-304f, 306a-306f may monitor the execution of a respective stage iteration 304a-304f, 306a-306f, wait for a ready signal from a previous ISC 310a-310l, and send a ready signal to a subsequent ISC 310a-310l, as described with reference to FIG. 3B. Each ISC 310a-310l may prevent the progression of the subsequent the ISC 310a-310l associated with the iteration order edge of the ISC 310a-310l, and prevent the execution of the stage iteration 304a-304f, 306a-306f associated with the DoC execution control edge of the ISC 310a-310l. The ISC 310c-310f implementing the iteration rate execution control edge may prevent the execution of the successive S3 stage iteration 306a-306f associated with the iteration rate execution control edge of the ISC 310b-310f. Once the preceding S2 stage iteration 304b-304f execution completes and/or a ready signal is received from a previous ISC 310a-310f, the ISC 310a-310f may send a ready signal to the ISC 310b-310f associated with the iteration order edge, allowing the associated ISC 310b-310f to progress when ready. The ISC 310b-310f may also relinquish the iteration rate control edge to the associated successive S3 stage iteration 306a-306f, allowing the associated stage iteration 306a-306f to execute.

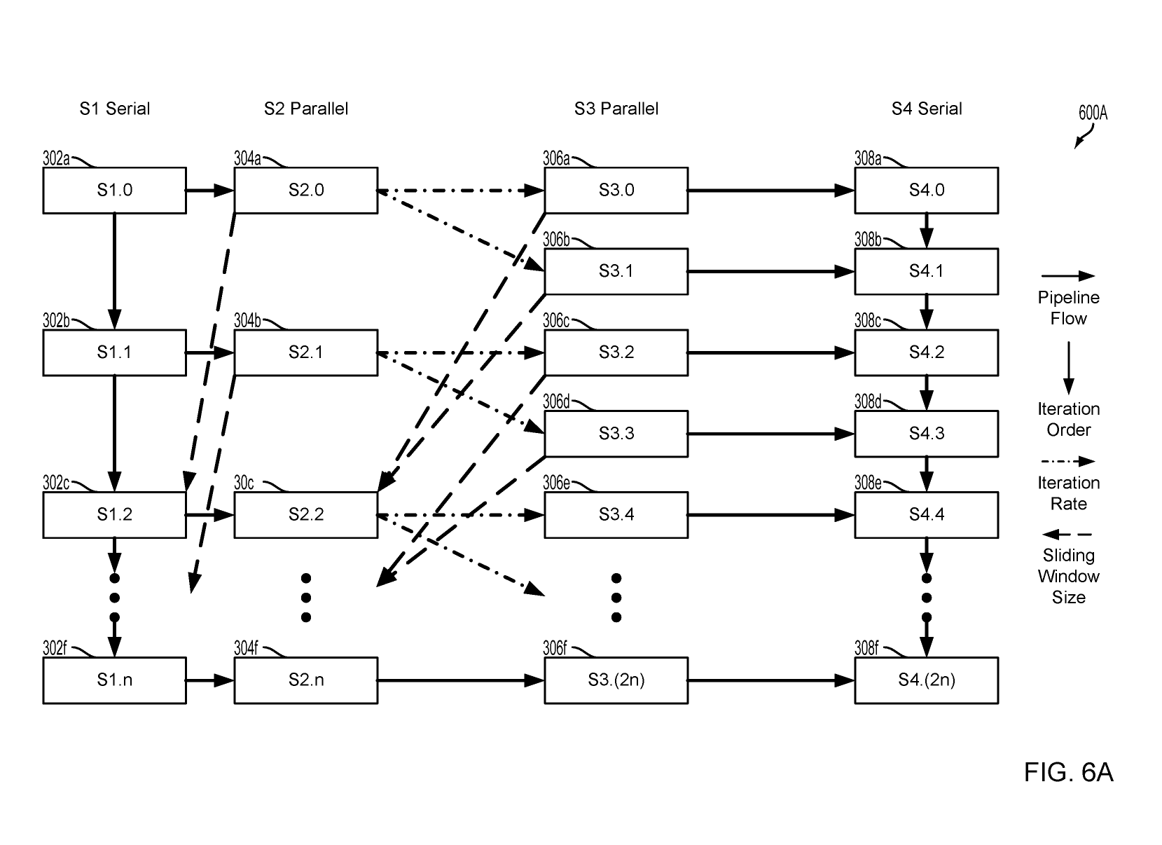

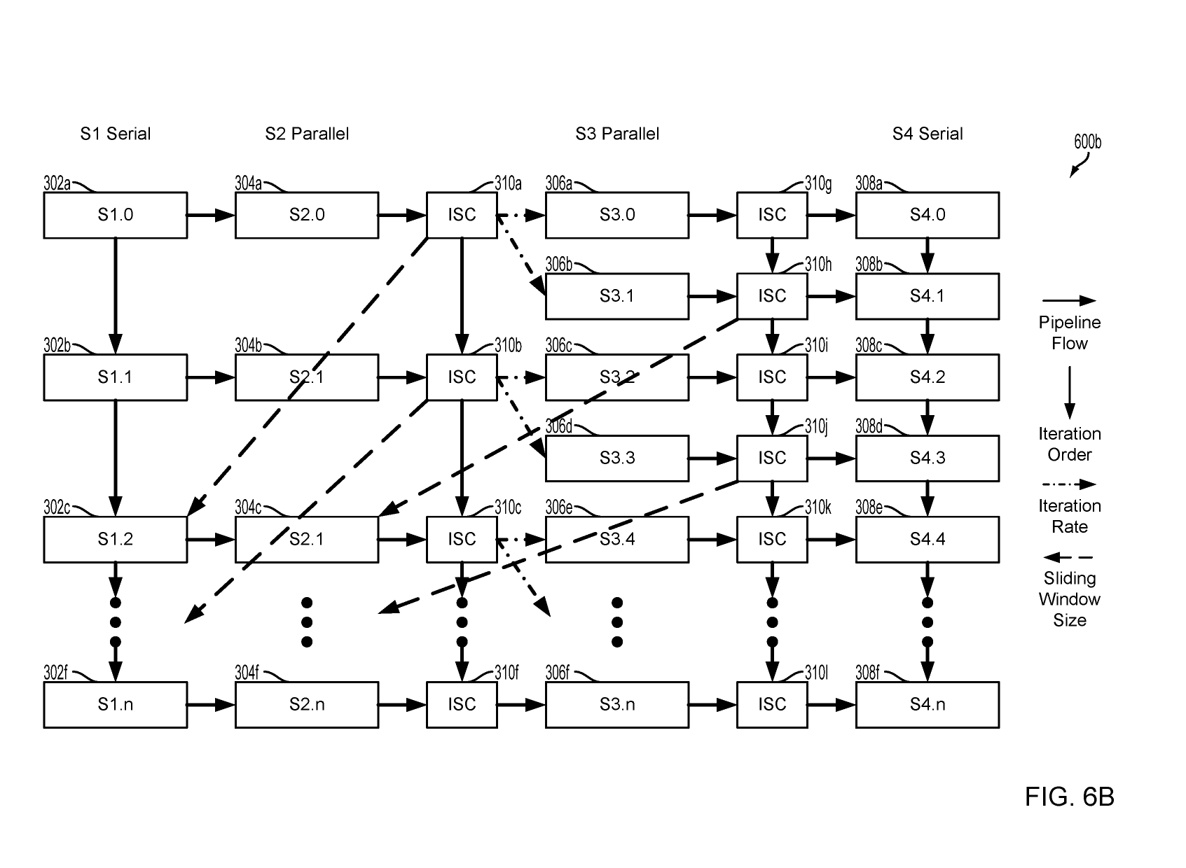

FIG. 6A illustrates an example embodiment of parallel pipeline processing with sliding window size control without implementing an iteration synchronization construct. The parallel pipeline 600a may include serial stage S1 with a sliding window size value of “2”, parallel stage S2 with a sliding window size value of “2”, and parallel stage S3 with an iteration rate value “1:2”. The iteration rate value of “1:2” for parallel stage S3 indicates that for every one preceding S2 stage iteration 304a-304f, only two S3 stage iterations 306a-306f (not all shown for the sake of clarity) may execute. An iteration rate execution control edge may be implemented in the same manner as described with reference to FIG. 5A.

The sliding window size value of “2” for serial stage S1 indicates that a successive S2 stage iteration 304a-304f (not all shown for the sake of clarity) two iterations before a preceding S1 stage iteration 302a-302f (not all shown for the sake of clarity) must execute before the preceding S1 stage iteration 302a-302f. Similarly, a sliding window size value of “2” for parallel stage S2 indicates that a successive S3 stage iteration 306a-306f (not all shown for the sake of clarity) two iterations before a preceding S2 stage iteration 304a-304f (not all shown for the sake of clarity) must execute before the preceding S2 stage iteration 304a-304f. In other words, the parallel execution of iterations of a preceding stage should be prevented until completion of an iteration of a stage that is a number of iterations higher than the iterations of the preceding stage equal to the sliding window size value. A sliding window size execution control edge extends from each successive stage iteration 304a-304f, 306a-306f, “i” of a stage “j” according to the sliding window size “sws”, from S(j+1).(floor((i−1−sws)*r2/r1)+1) to S(j+1).(floor((i−sws)*r2/r1), to preceding stage iterations 302a-302f, 304a-304f, Sj.i. The sliding window size execution control edges may be used to indicate the S1 or S2 stage iterations 302a-302f, 304a-304f connected to a tip of an sliding window size execution control edge that are prevented from executing before an S2 or S3 stage iteration 304a-304f, 306a-306f connected to the base of the sliding window size execution control edge.

FIG. 6B illustrates an example embodiment of parallel pipeline processing with sliding window size execution control implementing an iteration synchronization construct. The parallel pipeline 600b may include the same stages S1-S4, and the same stage iterations 302a-302f, 304a-304f, 306a-306f, 308a-308f (not all shown for the sake of clarity), as the parallel pipeline 600a. As in the parallel pipeline 600a, the parallel pipeline 600b may include serial stage S1 with a sliding window size value of “2”, parallel stage S2 with a sliding window size value of “2”, and parallel stage S3 with an iteration rate value “1:2”. The iteration rate execution control edges may be implemented in a manner as described with reference to FIG. 5B.

Further, rather than implementing multiple sliding window size execution control edges to control the S2 and S3 stage iterations 304a-304f, 306a-306f that must execute before certain S1 and S2 stage iterations 302a-302f, 304a-304f, the ISC 310a-310l (not all shown for the sake of clarity) may be configured to implement the same control function as the sliding window size execution control edges. The ISC 310a-310l may use the iteration order edge between the ISC 310a-310l of a stage iteration 304a-304f, 306a-306f as described with reference to FIG. 3B, and sliding window size execution control edges from an ISC 310a-310l of an S2 or S3 stage iteration 304a-304f, 306a-306f, S(j+1).(floor((i−sws)*r2/r1)), to an S1 or S2 stage iterations 302a-302f, 304a-304f, Sj.i.

To implement execution controls, the ISC 310a-310l for each parallel stage iteration 304a-304f, 306a-306f may monitor the execution of a respective stage iteration 304a-304f, 306a-306f, wait for a ready signal from a previous ISC 310a-310l, and send a ready signal to a subsequent ISC 310a-310l, as described with reference to FIG. 3B. Each ISC 310a-310l may prevent progression of the subsequent the ISC 310a-310l associated with the iteration order edge of the ISC 310a-310l, and prevent execution of the stage iteration 302a-302f, 304a-304f associated with the sliding window size execution control edge of the ISC 310a-310l. The ISC 310a-310f implementing the iteration rate execution control edge may prevent the execution of the successive S3 stage iteration 306a-306f associated with the iteration rate execution control edge of the ISC 310a-310l. Once the successive S2 or S3 stage iteration 304a-304f, 306a-306f execution completes and/or a ready signal is received from a previous ISC 310a-310l, the ISC 310a-310l may send a ready signal to the ISC 310b-310f, 310h-310l associated with the iteration order edge, allowing the associated ISC 310b-310f, 310h-310l to progress when ready. The ISC 310b-310f, 310h-310l may also relinquish the sliding window size execution control edge and/or iteration rate execution control edge to the associated preceding S1 or S2 stage iteration 302a-302f, 304a-304f, allowing the associated stage iteration 302a-302f, 304a-304f to execute.

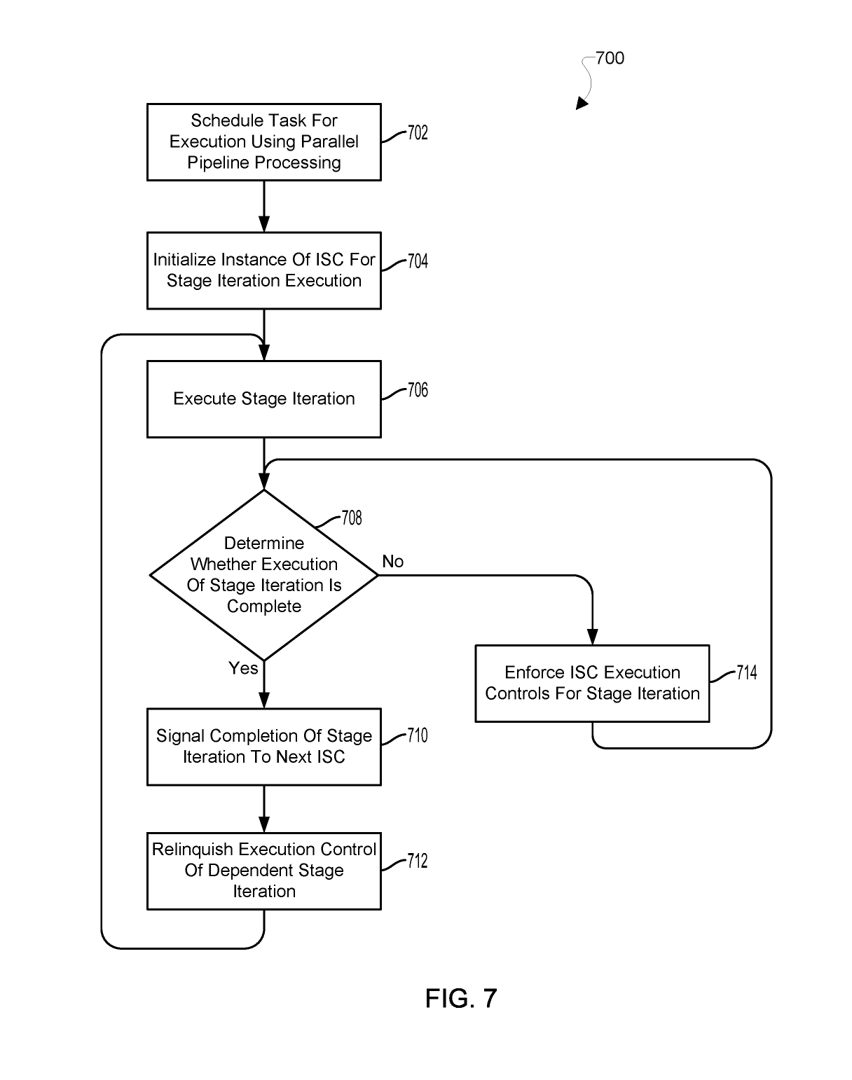

FIG. 7 illustrates a method 700 for implementing an ISC for parallel pipelines according to an embodiment. The method 700 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 700 is referred to herein as a “processing device.”

In block 702, the processing device may schedule a task for execution using parallel pipeline processing. In various embodiments, scheduling may be accomplished at an application level, a process level, a thread level, a task level, a work item level, etc.

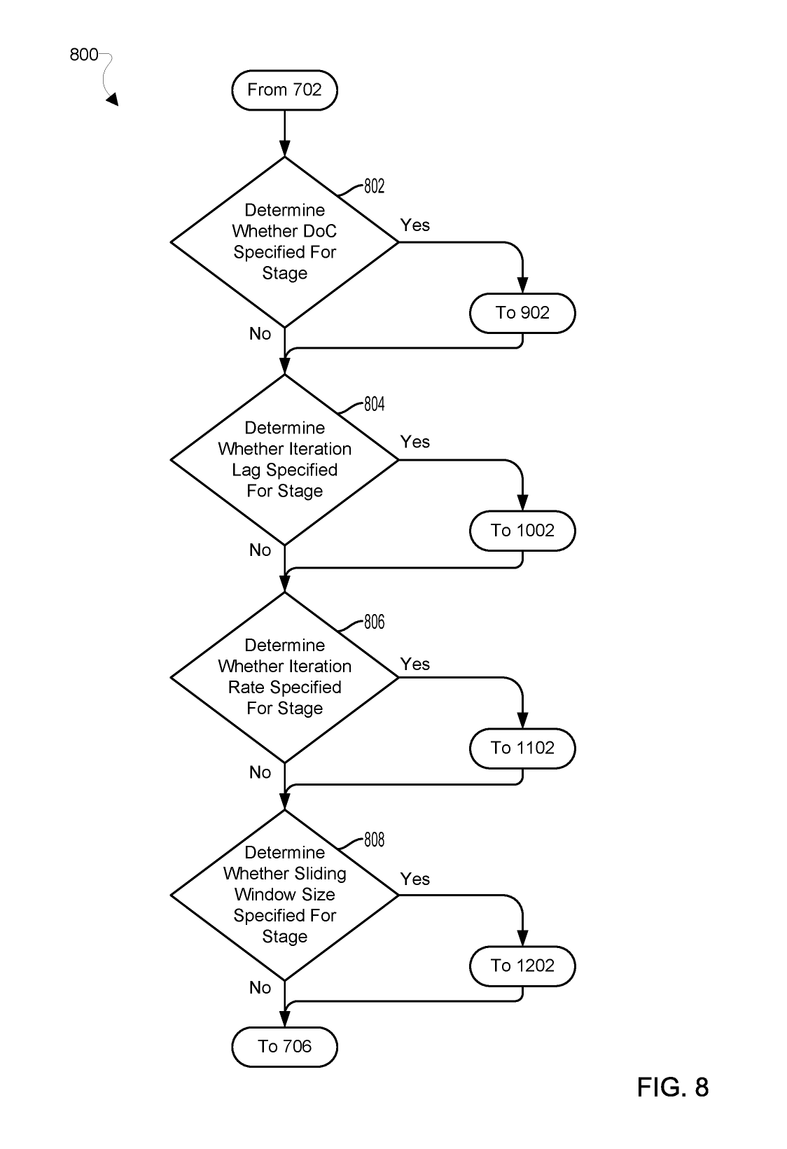

In block 704, the processing device may initialize instances of an ISC for stage iteration executions, as described further herein with reference to FIGS. 8-12. The stage iterations may be iterations of a parallel stage.

In block 706, the processing device may execute a stage iteration.

In block 708, the processing device may determine whether execution of the stage iteration is complete. In various embodiments, the processing device may implement the instance of the ISC to monitor the execution of the stage iteration. The processing device may determine whether the stage iteration is complete via a number of mechanisms, including receiving a completion signal, which may include a return value of the execution of the stage iteration, receiving a request for more work from a portion of the processing device that executed the stage iteration, and various measurements or observations of indicators of processing activity or lack of processing activity by the portion of the processing device that executed the stage iteration.

In response to determining that execution of the stage iteration is not complete (i.e., determination block 708=“No”), the processing device may enforce the ISC execution controls for the stage iteration in block 714. An instance of the ISC may prevent the execution of a stage iteration based on the execution controls enforcing execution control edges, also called dependencies. As described with reference to FIGS. 3B, 4B, 5B, and 6B, the ISC execution controls may include DoC execution controls, iteration lag execution controls, iteration rate execution controls, and sliding window size execution controls. The DoC execution controls may limit a number of parallel executions of the same stage. The iteration lag execution controls may prevent parallel execution of iterations of a successive stage until completion of a number of stage iterations. The iteration rate execution controls may prevent execution of a first number of stage iteration of a later stage until completion of execution of a second number of stage iteration of an earlier stage. The sliding window size execution controls may prevent execution of a stage iteration of an earlier stage until completion of execution of a stage iteration of a later stage a designated number of iterations higher. The ISC execution controls may also include ready signaling along iteration order edges that signal between multiple ISCs that a stage iteration is complete. The ready signal may indicate that the ready signal receiving ISC may relinquish its execution controls when execution of its associated stage iteration is complete.

In response to determining that execution of the stage iteration is not complete (i.e., determination block 708=“No”), the processing device may periodically or continually determining whether execution of the stage iteration is complete in determination block 708.

In response to determining that execution of the stage iteration is complete (i.e., determination block 708=“Yes”), the processing device may send a ready signal to a successive ISC, in block 710, to indicate completion of the state iteration associated with the preceding ISC.

In block 712, the processing device may relinquish execution controls to dependent stage iterations, and continue to execute stage iterations in block 706.

FIG. 8 illustrates a method 800 for initializing an instance of ISC for parallel pipelines in block 704 of the method 700 according to an embodiment. The method 800 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 800 is referred to herein as a “processing device.”

When the processing device has scheduled a task for execution using parallel pipeline processing in block 702 of the method 700, the processing device may determine whether a DoC value is specified for a parallel stage of the parallel pipeline execution of the scheduled task in determination block 802. In various embodiments, the processing device may be preprogrammed with a DoC value for the parallel stage, the processing device may be passed a DoC value for the parallel stage when the task is scheduled, and/or the processing device may retrieve a DoC value for the parallel stage from a memory accessible by the processing device. The memory may include a volatile or nonvolatile memory (e.g., the memory 16, 24 in FIG. 1).

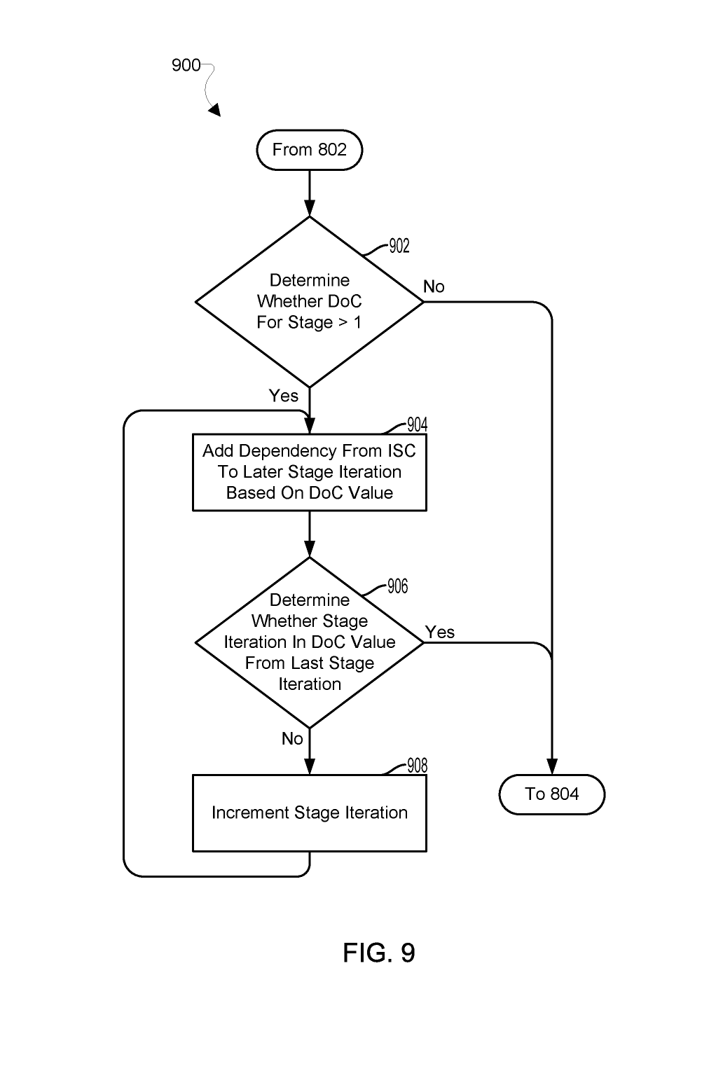

In response to determining that a DoC value is specified for a parallel stage of the parallel pipeline execution of the scheduled task (i.e., determination block 802=“Yes”), the processing device may implement the method 900 described below with reference FIG. 9.

In response to determining that a DoC value is not specified for a parallel stage of the parallel pipeline execution of the scheduled task (i.e., determination block 802=“No”), the processing device may determine whether an iteration lag value is specified between a parallel stage and a next stage of the parallel pipeline execution of the scheduled task in determination block 804. In various embodiments, the processing device may be preprogrammed with an iteration lag value for the stages, the processing device may be passed an iteration lag value for the stages when the task is scheduled, and/or the processing device may retrieve an iteration lag value for the stages from a memory accessible by the processing device. The memory may include a volatile or nonvolatile memory (e.g., the memory 16, 24 in FIG. 1).

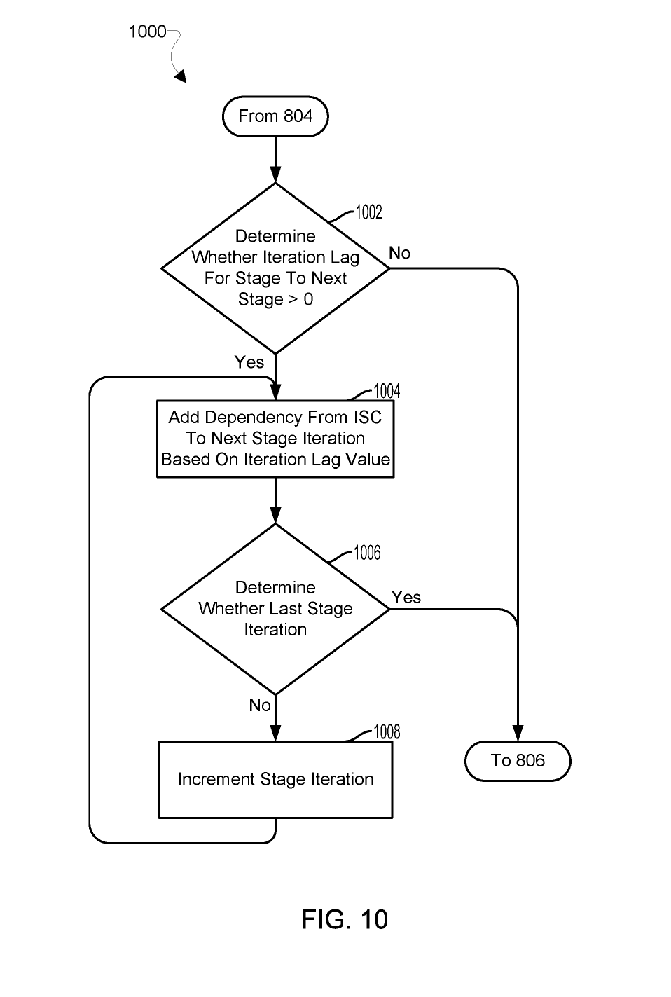

In response to determining that an iteration lag value is specified between a parallel stage and a next stage of the parallel pipeline execution of the scheduled task (i.e., determination block 804=“Yes”), the processing device may implement the method 1000 described below with reference to FIG. 10.

In response to determining that an iteration lag value is not specified between a parallel stage and a next stage of the parallel pipeline execution of the scheduled task (i.e., determination block 804=“No”), the processing device may determine whether an iteration rate value is specified between a parallel stage and a next stage of the parallel pipeline execution of the scheduled task in determination block 806. In various embodiments, the processing device may be preprogrammed with an iteration rate value for the stages, the processing device may be passed an iteration rate value for the stages when the task is scheduled, and/or the processing device may retrieve an iteration rate value for the stages from a memory accessible by the processing device. The memory may include a volatile or nonvolatile memory (e.g., the memory 16, 24 in FIG. 1).

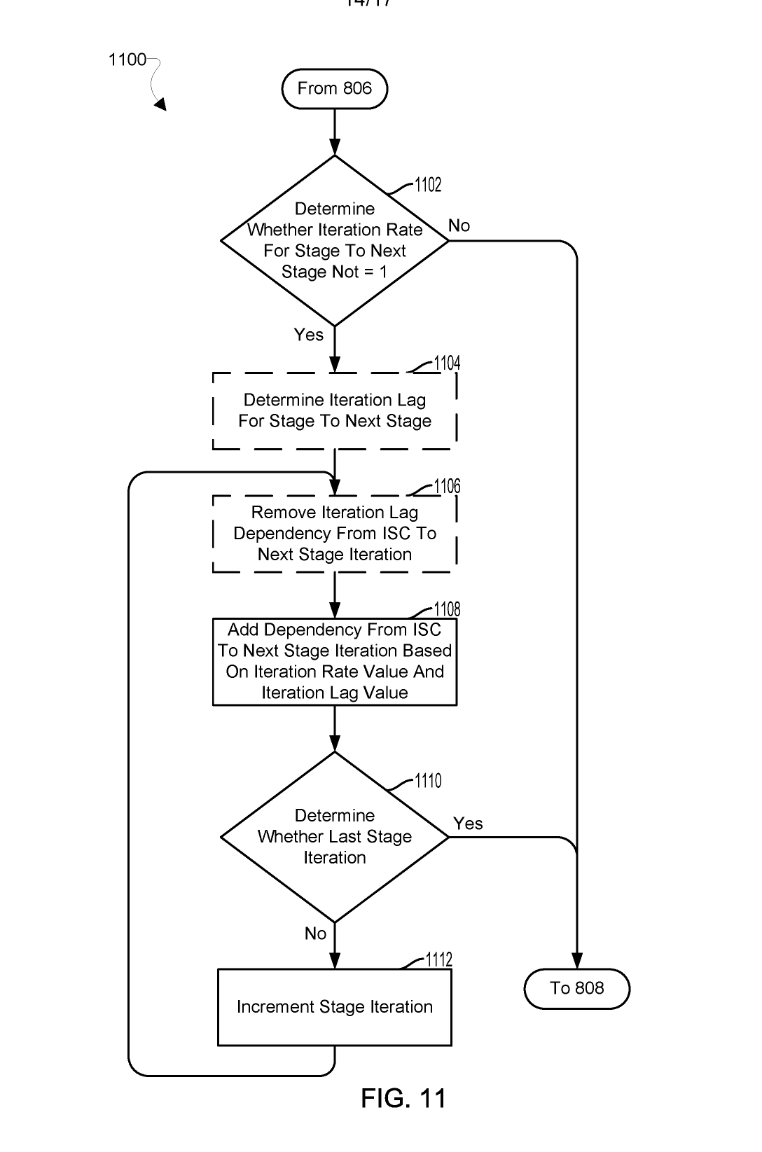

In response to determining that an iteration rate value is specified between a parallel stage and a next stage of the parallel pipeline execution of the scheduled task (i.e., determination block 806=“Yes”), the processing device may implement the method 1100 described below with reference to FIG. 11.

In response to determining that an iteration rate value is not specified between a parallel stage and a next stage of the parallel pipeline execution of the scheduled task (i.e., determination block 806=“No”), the processing device may determine whether a sliding widow size value is specified for a parallel stage of the parallel pipeline execution of the scheduled task in determination block 808. In various embodiments, the processing device may be preprogrammed with a sliding widow size value for the parallel stage, the processing device may be passed a sliding widow size value for the parallel stage when the task is scheduled, and/or the processing device may retrieve a sliding widow size value for the parallel stage from a memory accessible by the processing device. The memory may include a volatile or nonvolatile memory (e.g., the memory 16, 24 in FIG. 1).

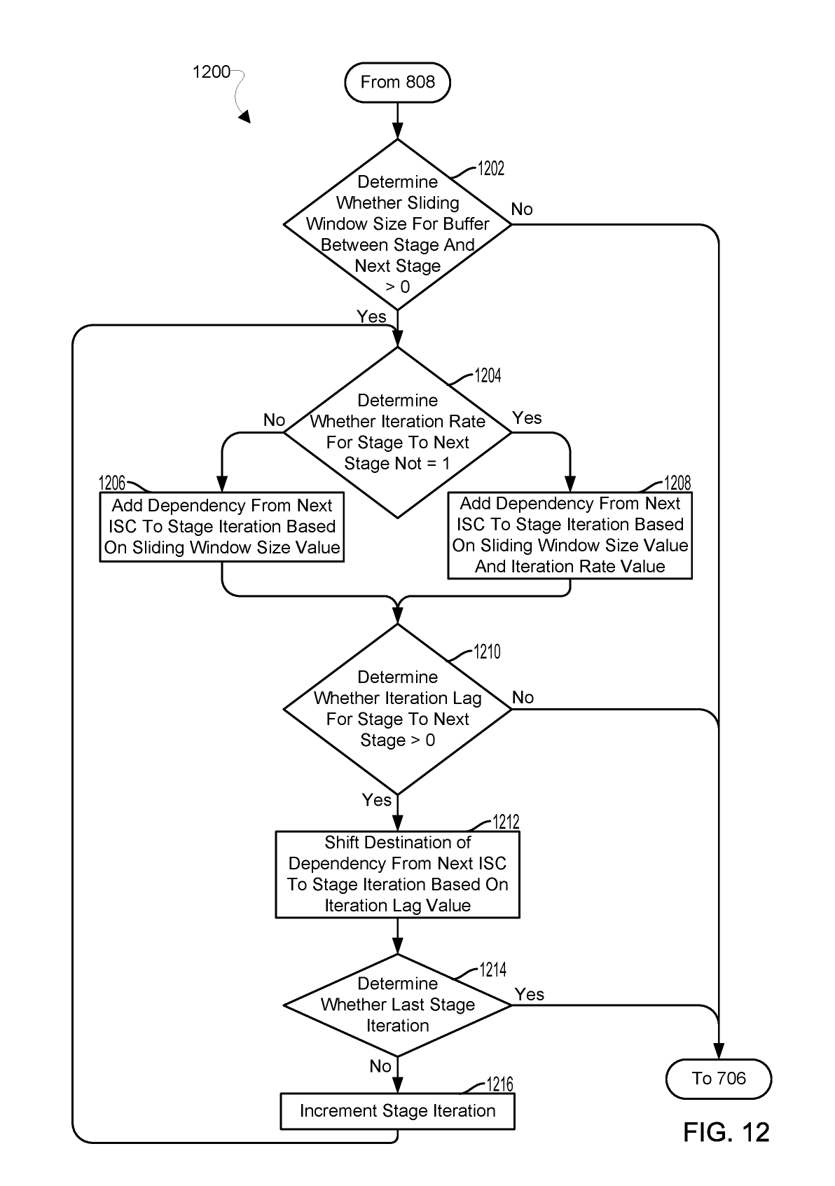

In response to determining that a sliding widow size value is specified for a parallel stage of the parallel pipeline execution of the scheduled task (i.e., determination block 808=“Yes”), the processing device may implement the method 1200 as described below with reference to FIG. 12.

In response to determining that a sliding widow size value is not specified for a parallel stage of the parallel pipeline execution of the scheduled task (i.e., determination block 808=“No”), the processing device may execute the stage iteration in block 706 of the method 700 described with reference to FIG. 7.

The order of blocks in the method 800 is merely one example and various embodiments may perform the operations in determination blocks 802-808 in different orders, combine some of the operations and/or include concurrent execution of multiple determination blocks 802-808. The order of blocks 802-808 may result in like modifications to the relationships between the methods 900-1200 and the blocks 802-808.

FIG. 9 illustrates a method 900 for initializing an instance of an ISC for parallel pipelines with DoC execution controls according to an embodiment. The method 900 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 900 is referred to herein as a “processing device.”

In determination block 902, the processing device may determine whether a DoC value is greater than “1” for a parallel stage of the parallel pipeline execution of the scheduled task. As discussed with reference to determination block 802 in the method 800, the processing device may be preprogrammed with, receive, and/or retrieve the DoC value. The processing device may determine whether the DoC value is greater than “1” using various computational and logical operations known to provide an output indicating whether a value is greater than “1”.

In response to determining that the DoC value is not greater than “1” for a parallel stage of the parallel pipeline execution of the scheduled task (i.e., determination block 902=“No”), the processing device may determine whether an iteration lag value is specified for a parallel stage of the parallel pipeline execution of the scheduled task in determination block 804 of the method 800.

In response to determining that the DoC value is greater than “1” for a parallel stage of the parallel pipeline execution of the scheduled task (i.e., determination block 902=“Yes”), the processing device may add a DoC execution control edge, or dependency, from the ISC to a stage iteration a number equal to the DoC value of iterations lower than the stage iteration associated with the ISC in block 904. In other words, the processing device may add a DoC execution control edge from the current ISC, associated with a current stage iteration, to a stage iteration a DoC value equivalent number lower than the current stage iteration. The DoC execution control edge may allow the ISC to control whether the lower stage iteration may be executed.

In determination block 906 the processing device may determine whether the current stage iteration (i.e., the one associated with the ISC for which the DoC execution control edge was added) is within a number of iterations less than or equal to the DoC value from a last stage iteration. The DoC value indicates the maximum number of stage iterations that may execute in parallel. Once the number of stage iterations left in the stage is equal to or less than the DoC value, there may be no need for additional DoC execution control edges.

In response to determining that the current stage iteration is not within a number of iterations less than or equal to the DoC value from a last stage iteration (i.e., determination block 906=“No”), the processing device may increment the stage iteration in block 908, and add a DoC execution control edge from the ISC associated with the incremented stage iteration in block 904.

In response to determining that the current stage iteration is within a number of iterations less than or equal to the DoC value from a last stage iteration (i.e., determination block 906=“Yes”), the processing device may determine whether an iteration lag value is specified between a parallel stage and a next stage of the parallel pipeline execution of the scheduled task in determination block 804 of the method 800.

FIG. 10 illustrates a method 1000 for initializing an instance of ISC for parallel pipelines with iteration lag execution controls according to an embodiment. The method 1000 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 1000 is referred to herein as a “processing device.”

In determination block 1002, the processing device may determine whether an iteration lag value is greater than “0” between a parallel stage and a next stage of the parallel pipeline execution of the scheduled task. As discussed with reference to determination block 804 in the method 800, the processing device may be preprogrammed with, receive, and/or retrieve the iteration lag value. The processing device may determine whether the iteration lag value is greater than “0” using various computational and logical operations known to provide an output indicating whether a value is greater than “0”.

In response to determining that the iteration lag value between a parallel stage and a next stage of the parallel pipeline execution of the scheduled task is not greater than “0” (i.e., determination block 1002=“No”), the processing device may determine whether an iteration rate value is specified between a parallel stage and a next stage of the parallel pipeline execution of the scheduled task in determination block 806 of the method 800.

In response to determining that the iteration lag value between a parallel stage and a next stage of the parallel pipeline execution of the scheduled task is greater than “0” (i.e., determination block 1002=“Yes”), the processing device may add an iteration lag execution control edge, or dependency, from an ISC associated with a stage iteration a number equal to the iteration lag value of iterations lower than the current stage iteration to a stage iteration of a successive stage at an equal level of the current stage iteration in block 1004. In other words, the processing device may add an iteration lag execution control edge between an ISC an iteration lag equivalent value lower to the current stage iteration and a stage iteration in a successive stage at the same level as the current stage iteration. The iteration lag execution control edge may allow the ISC to control whether the successive stage iteration may be executed.

In determination block 1006 the processing device may determine whether the current stage iteration is a last stage iteration. In response to determining that the current stage iteration is not a last stage iteration (i.e., determination block 1006=“No”), the processing device may increment the stage iteration in block 1008, and add an iteration lag execution control edge, from the ISC the number equivalent to the iteration lag value lower than the ISC associated with the incremented stage iteration in block 1004.

In response to determining that the current stage iteration is a last stage iteration (i.e., determination block 1006=“Yes”), the processing device may determine whether an iteration rate value is specified between a parallel stage and a next stage of the parallel pipeline execution of the scheduled task in determination block 806 of the method 800.

FIG. 11 illustrates a method 1100 for initializing an instance of ISC for parallel pipelines with iteration rate execution controls according to an embodiment. The method 1100 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 1100 is referred to herein as a “processing device.”

In determination block 1102, the processing device may determine whether an iteration rate value is not equal to “1” between a parallel stage and a next stage of the parallel pipeline execution of the scheduled task. As discussed with reference to determination block 806 in the method 800, the processing device may be preprogrammed with, receive, and/or retrieve the iteration rate value. The processing device may determine whether the iteration rate value is not equal to “1” using various computational and logical operations known to provide an output indicating whether a value is not equal to “1”.

In response to determining that the iteration rate value is equal to “1” for between a parallel stage and a next stage of the parallel pipeline execution of the scheduled task (i.e., determination block 1102=“No”), the processing device may determine whether a sliding window size value is specified for between a parallel stage and a next stage of the parallel pipeline execution of the scheduled task in determination block 808 of the method 800.

In response to determining that the iteration rate value is not equal to “1” for between a parallel stage and a next stage of the parallel pipeline execution of the scheduled task (i.e., determination block 1102=“Yes”), the processing device may determine the iteration lag value between a parallel stage and a next stage of the parallel pipeline execution of the scheduled task in optional block 1104. As discussed with reference to determination block 804 in the method 800, the processing device may be preprogrammed with, receive, and/or retrieve the iteration lag value.

In optional block 1106, the processing device may remove iteration lag execution control edges for the current ISC. In various embodiments, an iteration rate execution control edge may preempt an iteration lag execution control edge.

In block 1108, the processing device may add an iteration rate execution control edge, or dependency, from an ISC associated with a current stage iteration to one or more stage iterations of a successive stage based on a ratio of the iteration rate value. For example, a ratio greater than one, such as 2:1, may result in one iteration rate execution control edge, and a ratio less than one, such as 1:2 may result in multiple iteration rate execution control edges. In some embodiments, the determination of an iteration lag value may factor into the assignment of iteration rate execution control edges. The higher the iteration lag value, the fewer iteration rate execution control edges needed. The iteration rate execution control edge may allow the ISC to control whether the successive stage iteration may be executed.

In determination block 1110 the processing device may determine whether the current stage iteration is a last stage iteration. In response to determining that the current stage iteration is not a last stage iteration (i.e., determination block 1110=“No”), the processing device may increment the stage iteration in block 1112; remove iteration lag execution control edges for the current ISC in optional block 1106; and add an iteration rate execution control edge, or dependency, from an ISC associated with a current stage iteration to one or more stage iterations of a successive stage based on a ratio of the iteration rate value in block 1008.

In response to determining that the current stage iteration is a last stage iteration (i.e., determination block 1110=“Yes”), the processing device may determine whether a sliding window size value is specified for a parallel stage of the parallel pipeline execution of the scheduled task in determination block 808 of the method 800.

FIG. 12 illustrates a method 1200 for initializing an instance of ISC for parallel pipelines with sliding window size execution controls according to an embodiment. The method 1200 may be implemented in a computing device in software executing in a processor (e.g., the processor 14 in FIGS. 1 and 2), in general purpose hardware, in dedicated hardware, or in a combination of a processor and dedicated hardware, such as a processor executing software within an ISC system that includes other individual components. In order to encompass the alternative configurations enabled in the various embodiments, the hardware implementing the method 1200 is referred to herein as a “processing device.”

In determination block 1202, the processing device may determine whether a sliding window size value for a buffer between two stages of the parallel pipeline execution of the scheduled task is greater than “0”. As discussed with reference to determination block 808 in the method 800, the processing device may be preprogrammed with, receive, and/or retrieve the sliding window size value. The processing device may determine whether the sliding window size value is greater than “0” using various computational and logical operations known to provide an output indicating whether a value is greater than “0”.

In response to determining that the sliding window size value for a buffer between two stages of the parallel pipeline execution of the scheduled task is not greater than “0” (i.e., determination block 1202=“No”), the processing device may execute the stage iteration in block 706 of the method 700.

In response to determining that the sliding window size value for a buffer between two stages of the parallel pipeline execution of the scheduled task is greater than “0” (i.e., determination block 1202=“Yes”), the processing device may determine whether an iteration rate value between the stages of the parallel pipeline execution of the scheduled task is not equal to “1” in determination block 1204. The determination of determination block 1204 may be implemented in a manner similar to the operations in determination block 1102 of the method 1100.

In response to determining that the iteration rate value between the stages of the parallel pipeline execution of the scheduled task is equal to “1” (i.e., determination block 1204=“No”), the processing device may add a sliding window execution control, or dependency, from an ISC associated with a stage iteration of a stage succeeding the current stage of the current stage iteration and a number equivalent to the sliding window value higher than the current stage iteration, to the current stage iteration in block 1206. In other words, the sliding window execution control is added from an ISC of a later stage at a level higher than the current stage iteration by a number equal to the sliding window size value, to the current stage iteration.

In response to determining that the iteration rate value between the stages of the parallel pipeline execution of the scheduled task is not equal to “1” (i.e., determination block 1204=“Yes”), the processing device may add a sliding window execution control, or dependency, from an ISC associated with a stage iteration of a stage succeeding the current stage of the current stage iteration and a number equivalent to the sliding window value modified by the iteration rate value higher than the current stage iteration, to the current stage iteration in block 1208. In other words, the sliding window execution control is added from an ISC of a later stage at a level higher than the current stage iteration by a number equal to the sliding window size value modified by the iteration rate value, to the current stage iteration.

Following adding the sliding window execution control in block 1206 or block 1208, the processing device may determine whether an iteration lag value between the stages of the parallel pipeline execution of the scheduled task is greater than “0” in determination block 1210. This determination may be implemented in a manner similar to the operations in determination block 1002 of the method 1000.

In response to determining that the iteration lag value between the stages of the parallel pipeline execution of the scheduled task is not greater than “0” (i.e., determination block 1210=“No”), the processing device may execute the stage iteration in block 706 of the method 700.

In response to determining that the iteration lag value between the stages of the parallel pipeline execution of the scheduled task is greater than “0” (i.e., determination block 1210=“Yes”), the processing device may shift the sliding window execution control to the current stage iteration to a stage iteration of the current stage a number lower equivalent to the iteration lag value in block 1212. In other words, the sliding window execution control of the dependent stage iteration is shifted to a lower stage iteration by an amount equal to the iteration lag value.

In determination block 1214 the processing device may determine whether the current stage iteration is a last stage iteration. In response to determining that the current stage iteration is not a last stage iteration (i.e., determination block 1214=“No”), the processing device may increment the stage iteration in block 1216 and determine whether an iteration rate value between the stages of the parallel pipeline execution of the scheduled task is not equal to “1” in determination block 1204.

In response to determining that the current stage iteration is a last stage iteration (i.e., determination block 1214=“Yes”), the processing device may execute the stage iteration in block 706 of the method 700.

In the descriptions of the embodiment methods 700-1200, specific values, including “0” and “1,” are used as non-limiting examples for or as comparisons with the DoC, iteration lag, iteration rate, and sliding window size values. The DoC, iteration lag, iteration rate, and sliding window size values may be any value capable of satisfying the functions described herein, either in an unaltered or altered form (e.g., altered by an offset, a hash function, a logical operation, or an arithmetic operation). Similarly, comparators, such as greater than, greater than or equal to, less than, less than or equal to, and equal to, are used as non-limiting examples as comparators for the DoC, iteration lag, iteration rate, and sliding window size values. In various embodiments, different comparators may be used with each of the DoC, iteration lag, iteration rate, and sliding window size values.

Parallel pipelines may execute over distributed computing devices easily, using any number of possible mechanisms for distribution, including message-passing (e.g., MPI), distributed shared memory, map-reduce frameworks, etc. The addition of the ISC rides on whatever mechanism may already exist to distribute pipeline stage iterations across computing devices and satisfy dependence edges across machines. For example, execution of a parallel pipeline across over distributed computing devices may include execution across multiple servers or across mobile computing devices and a server in a cloud.

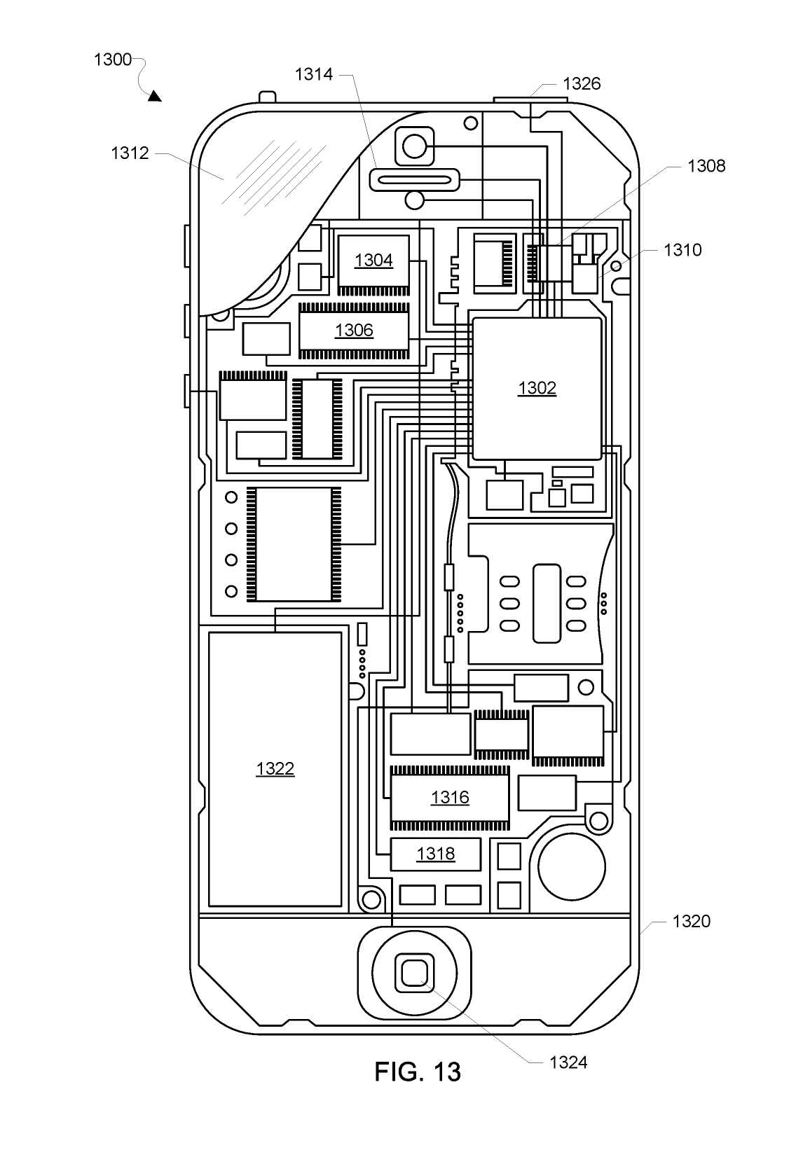

The various embodiments (including, but not limited to, embodiments described above with reference to FIGS. 1-12) may be implemented in a wide variety of computing systems including mobile computing devices, an example of which suitable for use with the various embodiments is illustrated in FIG. 13. The mobile computing device 1300 may include a processor 1302 coupled to a touchscreen controller 1304 and an internal memory 1306. The processor 1302 may be one or more multicore integrated circuits designated for general or specific processing tasks. The internal memory 1306 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1304 and the processor 1302 may also be coupled to a touchscreen panel 1312, such as a resistive-sensing touchscreen, capacitive-sensing touchscreen, infrared sensing touchscreen, etc. Additionally, the display of the computing device 1300 need not have touch screen capability.

The mobile computing device 1300 may have one or more radio signal transceivers 1308 (e.g., Peanut, Bluetooth, Zigbee, Wi-Fi, RF radio) and antennae 1310, for sending and receiving communications, coupled to each other and/or to the processor 1302. The transceivers 1308 and antennae 1310 may be used with the above-mentioned circuitry to implement the various wireless transmission protocol stacks and interfaces. The mobile computing device 1300 may include a cellular network wireless modem chip 1316 that enables communication via a cellular network and is coupled to the processor.

The mobile computing device 1300 may include a peripheral device connection interface 1318 coupled to the processor 1302. The peripheral device connection interface 1318 may be singularly configured to accept one type of connection, or may be configured to accept various types of physical and communication connections, common or proprietary, such as Universal Serial Bus (USB), FireWire, Thunderbolt, or PCIe. The peripheral device connection interface 1318 may also be coupled to a similarly configured peripheral device connection port (not shown).

The mobile computing device 1300 may also include speakers 1314 for providing audio outputs. The mobile computing device 1300 may also include a housing 1320, constructed of a plastic, metal, or a combination of materials, for containing all or some of the components described herein. The mobile computing device 1300 may include a power source 1322 coupled to the processor 1302, such as a disposable or rechargeable battery. The rechargeable battery may also be coupled to the peripheral device connection port to receive a charging current from a source external to the mobile computing device 1300. The mobile computing device 1300 may also include a physical button 1324 for receiving user inputs. The mobile computing device 1300 may also include a power button 1326 for turning the mobile computing device 1300 on and off.

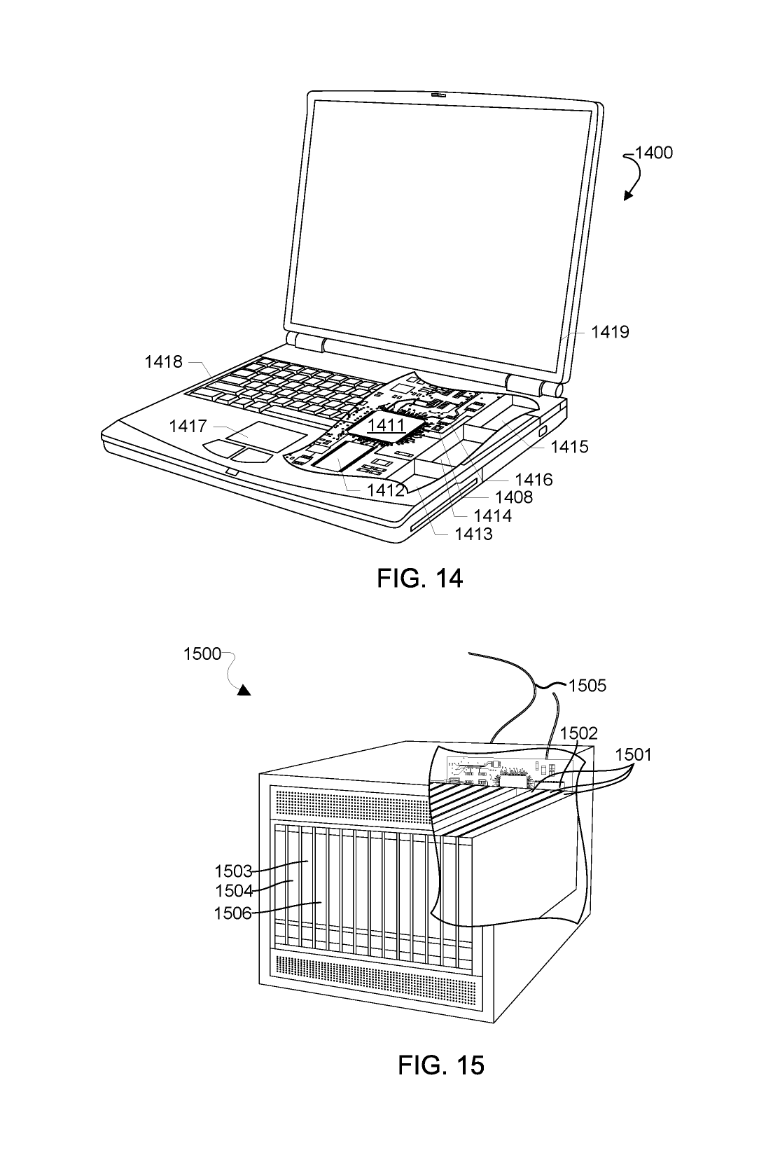

The various embodiments (including, but not limited to, embodiments described above with reference to FIGS. 1-12) may be implemented in a wide variety of computing systems include a laptop computer 1400 an example of which is illustrated in FIG. 14. Many laptop computers include a touchpad touch surface 1417 that serves as the computer's pointing device, and thus may receive drag, scroll, and flick gestures similar to those implemented on computing devices equipped with a touch screen display and described above. A laptop computer 1400 will typically include a processor 1411 coupled to volatile memory 1412 and a large capacity nonvolatile memory, such as a disk drive 1413 of Flash memory. Additionally, the computer 1400 may have one or more antenna 1408 for sending and receiving electromagnetic radiation that may be connected to a wireless data link and/or cellular telephone transceiver 1416 coupled to the processor 1411. The computer 1400 may also include a floppy disc drive 1414 and a compact disc (CD) drive 1415 coupled to the processor 1411. In a notebook configuration, the computer housing includes the touchpad 1417, the keyboard 1418, and the display 1419 all coupled to the processor 1411. Other configurations of the computing device may include a computer mouse or trackball coupled to the processor (e.g., via a USB input) as are well known, which may also be used in conjunction with the various embodiments.

The various embodiments (including, but not limited to, embodiments described above with reference to FIGS. 1-12) may also be implemented in fixed computing systems, such as any of a variety of commercially available servers. An example server 1500 is illustrated in FIG. 15. Such a server 1500 typically includes one or more multi-core processor assemblies 1501 coupled to volatile memory 1502 and a large capacity nonvolatile memory, such as a disk drive 1504. As illustrated in FIG. 15, multi-core processor assemblies 1501 may be added to the server 1500 by inserting them into the racks of the assembly. The server 1500 may also include a floppy disc drive, compact disc (CD) or digital versatile disc (DVD) disc drive 1506 coupled to the processor 1501. The server 1500 may also include network access ports 1503 coupled to the multi-core processor assemblies 1501 for establishing network interface connections with a network 1505, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of managing operations in a parallel pipeline on a computing device, comprising:
initializing a plurality of instances of an iteration synchronization construct (ISC) for a plurality of stage iterations of a parallel stage of the parallel pipeline, wherein the plurality of instances of the ISC includes a first instance of the ISC for a first stage iteration of a first parallel stage of the parallel pipeline and a second instance of the ISC for a second stage iteration of the first parallel stage of the parallel pipeline;
determining whether execution of the first stage iteration is complete; and
sending a ready signal from the first instance of the ISC to the second instance of the ISC in response to determining that execution of the first stage iteration is complete.

2. The method of claim 1, wherein the plurality of instances of the ISC includes a third instance of the ISC for a third stage iteration of the first parallel stage of the parallel pipeline and a fourth instance of the ISC for a fourth stage iteration of a second parallel stage of the parallel pipeline,
the method further comprising relinquishing an execution control edge from at least one of the third stage iteration and the fourth stage iteration depending on the first instance of the ISC in response to determining that the first stage iteration is complete.

3. The method of claim 1, wherein the plurality of instances of the ISC includes a third instance of the ISC for a third stage iteration of the first parallel stage of the parallel pipeline, the method further comprising:
determining whether an execution control value is specified for the first stage iteration; and
adding a first execution control edge for the third stage iteration depending on the first instance of the ISC in response to determining that an execution control value is specified for the first stage iteration.

4. The method of claim 3, wherein:
determining whether an execution control value is specified for the first stage iteration comprises determining whether a degree of concurrency value is specified for the first parallel stage; and
the third stage iteration is a number of stage iterations lower in the first parallel stage than the first stage iteration, wherein the number is derived from the degree of concurrency value.

5. The method of claim 1, wherein the plurality of instances of the ISC includes a third instance of the ISC for a third stage iteration of a second parallel stage of the parallel pipeline, the method further comprising:
determining whether an execution control value is specified for the first stage iteration; and
adding a first execution control edge for the third stage iteration depending on the first instance of the ISC in response to determining that an execution control value is specified for the first stage iteration.

6. The method of claim 5, wherein:
the second parallel stage succeeds the first parallel stage;
determining whether an execution control value is specified for the first stage iteration comprises determining whether an iteration lag value is specified for between the first parallel stage and the second parallel stage; and
the third stage iteration is a number of stage iterations higher in the second parallel stage than the first stage iteration in the first parallel stage, wherein the number is derived from the iteration lag value.

7. The method of claim 5, wherein:
the second parallel stage succeeds the first parallel stage;
the plurality of instances of the ISC includes a fourth instance of the ISC for a fourth stage iteration of the second parallel stage of the parallel pipeline;
determining whether an execution control value is specified for the first stage iteration comprises determining whether an iteration rate value is specified for between the first parallel stage and the second parallel stage; and
the third stage iteration is in a range of stage iterations in the second parallel stage, wherein the range is derived from the iteration rate value,
the method further comprising adding a second execution control edge to the parallel pipeline for the fourth stage iteration depending on the first instance of the ISC, wherein the fourth stage iteration is in the range of stage iterations in the second parallel stage.

8. The method of claim 5, wherein:
the second parallel stage precedes the first parallel stage;
determining whether an execution control value is specified for the first stage iteration comprises determining whether a sliding window size value is specified for between the second parallel stage and the first parallel stage; and
the third stage iteration is a number of stage iterations lower in the second parallel stage than the first stage iteration in the first parallel stage, wherein the number is derived from the sliding window size value.

9. A processing device for managing operations in a parallel pipeline, the processing device configured to perform operations comprising:
initializing a plurality of instances of an iteration synchronization construct (ISC) for a plurality of stage iterations of a parallel stage of the parallel pipeline, wherein the plurality of instances of the ISC includes a first instance of the ISC for a first stage iteration of a first parallel stage of the parallel pipeline and a second instance of the ISC for a second stage iteration of the first parallel stage of the parallel pipeline;
determining whether execution of the first stage iteration is complete; and
sending a ready signal from the first instance of the ISC to the second instance of the ISC in response to determining that execution of the first stage iteration is complete.

10. The processing device of claim 9, wherein the plurality of instances of the ISC includes a third instance of the ISC for a third stage iteration of the first parallel stage of the parallel pipeline and a fourth instance of the ISC for a fourth stage iteration of a second parallel stage of the parallel pipeline, and
wherein the processing device is configured to perform operations further comprising relinquishing an execution control edge from at least one of the third stage iteration and the fourth stage iteration depending on the first instance of the ISC in response to determining that the first stage iteration is complete.

11. The processing device of claim 9, wherein the plurality of instances of the ISC includes a third instance of the ISC for a third stage iteration of the first parallel stage of the parallel pipeline, and
wherein the processing device is configured to perform operations further comprising:
determining whether an execution control value is specified for the first stage iteration; and
adding a first execution control edge for the third stage iteration depending on the first instance of the ISC in response to determining that an execution control value is specified for the first stage iteration.

12. The processing device of claim 11, wherein the processing device is configured to perform operations such that determining whether an execution control value is specified for the first stage iteration comprises determining whether a degree of concurrency value is specified for the first parallel stage, wherein the third stage iteration is a number of stage iterations lower in the first parallel stage than the first stage iteration, and wherein the number is derived from the degree of concurrency value.

13. The processing device of claim 9, wherein the plurality of instances of the ISC includes a third instance of the ISC for a third stage iteration of a second parallel stage of the parallel pipeline, and
wherein the processing device is configured to perform operations further comprising:
determining whether an execution control value is specified for the first stage iteration; and
adding a first execution control edge for the third stage iteration depending on the first instance of the ISC in response to determining that an execution control value is specified for the first stage iteration.

14. The processing device of claim 13, wherein:
the second parallel stage succeeds the first parallel stage; and
the processing device is configured to perform operations such that determining whether an execution control value is specified for the first stage iteration comprises determining whether an iteration lag value is specified for between the first parallel stage and the second parallel stage, wherein the third stage iteration is a number of stage iterations higher in the second parallel stage than the first stage iteration in the first parallel stage, and wherein the number is derived from the iteration lag value.

15. The processing device of claim 13, wherein:
the second parallel stage succeeds the first parallel stage;
the plurality of instances of the ISC includes a fourth instance of the ISC for a fourth stage iteration of the second parallel stage of the parallel pipeline;
the processing device is configured to perform operations such that determining whether an execution control value is specified for the first stage iteration comprises determining whether an iteration rate value is specified for between the first parallel stage and the second parallel stage, wherein the third stage iteration is in a range of stage iterations in the second parallel stage, and wherein the range is derived from the iteration rate value; and
the processing device is configured to perform operations further comprising adding a second execution control edge to the parallel pipeline for the fourth stage iteration depending on the first instance of the ISC, wherein the fourth stage iteration is in the range of stage iterations in the second parallel stage.

16. The processing device of claim 13, wherein:
the second parallel stage precedes the first parallel stage; and
the processing device is configured to perform operations such that determining whether an execution control value is specified for the first stage iteration comprises determining whether a sliding window size value is specified for between the second parallel stage and the first parallel stage, wherein the third stage iteration is a number of stage iterations lower in the second parallel stage than the first stage iteration in the first parallel stage, and wherein the number is derived from the sliding window size value.

17. A processing device for managing operations in a parallel pipeline, comprising:
means for initializing a plurality of instances of an iteration synchronization construct (ISC) for a plurality of stage iterations of a parallel stage of the parallel pipeline, wherein the plurality of instances of the ISC includes a first instance of the ISC for a first stage iteration of a first parallel stage of the parallel pipeline and a second instance of the ISC for a second stage iteration of the first parallel stage of the parallel pipeline;
means for determining whether execution of the first stage iteration is complete; and
means for sending a ready signal from the first instance of the ISC to the second instance of the ISC in response to determining that execution of the first stage iteration is complete.

18. The processing device of claim 17, wherein the plurality of instances of the ISC includes a third instance of the ISC for a third stage iteration of the first parallel stage of the parallel pipeline and a fourth instance of the ISC for a fourth stage iteration of a second parallel stage of the parallel pipeline, and
the processing device further comprises means for relinquishing an execution control edge from at least one of the third stage iteration and the fourth stage iteration depending on the first instance of the ISC in response to determining that the first stage iteration is complete.

19. The processing device of claim 17, wherein the plurality of instances of the ISC includes a third instance of the ISC for a third stage iteration of the first parallel stage of the parallel pipeline, and
wherein the processing device further comprises:
means for determining whether an execution control value is specified for the first stage iteration; and
means for adding a first execution control edge for the third stage iteration depending on the first instance of the ISC in response to determining that an execution control value is specified for the first stage iteration.

20. The processing device of claim 19, wherein means for determining whether an execution control value is specified for the first stage iteration comprises means for determining whether a degree of concurrency value is specified for the first parallel stage, wherein the third stage iteration is a number of stage iterations lower in the first parallel stage than the first stage iteration, and wherein the number is derived from the degree of concurrency value.

21. The processing device of claim 17, wherein the plurality of instances of the ISC includes a third instance of the ISC for a third stage iteration of a second parallel stage of the parallel pipeline, and
wherein the processing device further comprises:
means for determining whether an execution control value is specified for the first stage iteration; and
means for adding a first execution control edge for the third stage iteration depending on the first instance of the ISC in response to determining that an execution control value is specified for the first stage iteration.

22. The processing device of claim 21, wherein:
the second parallel stage succeeds the first parallel stage; and
means for determining whether an execution control value is specified for the first stage iteration comprises means for determining whether an iteration lag value is specified for between the first parallel stage and the second parallel stage, wherein the third stage iteration is a number of stage iterations higher in the second parallel stage than the first stage iteration in the first parallel stage, and wherein the number is derived from the iteration lag value.

23. The processing device of claim 21, wherein:
the second parallel stage succeeds the first parallel stage;
the plurality of instances of the ISC includes a fourth instance of the ISC for a fourth stage iteration of the second parallel stage of the parallel pipeline;
means for determining whether an execution control value is specified for the first stage iteration comprises means for determining whether an iteration rate value is specified for between the first parallel stage and the second parallel stage, wherein the third stage iteration is in a range of stage iterations in the second parallel stage, and wherein the range is derived from the iteration rate value; and
the processing device further comprising means for adding a second execution control edge to the parallel pipeline for the fourth stage iteration depending on the first instance of the ISC, wherein the fourth stage iteration is in the range of stage iterations in the second parallel stage.

24. The processing device of claim 21, wherein:
the second parallel stage precedes the first parallel stage; and
means for determining whether an execution control value is specified for the first stage iteration comprises means for determining whether a sliding window size value is specified for between the second parallel stage and the first parallel stage, wherein the third stage iteration is a number of stage iterations lower in the second parallel stage than the first stage iteration in the first parallel stage, and wherein the number is derived from the sliding window size value.

25. A non-transitory processor-readable storage medium having stored thereon processor-executable instructions configured to cause a processor of a computing device to perform operations comprising:
initializing a plurality of instances of an iteration synchronization construct (ISC) for a plurality of stage iterations of a parallel stage of a parallel pipeline, wherein the plurality of instances of the ISC includes a first instance of the ISC for a first stage iteration of a first parallel stage of the parallel pipeline and a second instance of the ISC for a second stage iteration of the first parallel stage of the parallel pipeline;
determining whether execution of the first stage iteration is complete; and
sending a ready signal from the first instance of the ISC to the second instance of the ISC in response to determining that execution of the first stage iteration is complete.

26. The non-transitory processor-readable storage medium of claim 25, wherein the plurality of instances of the ISC includes a third instance of the ISC for a third stage iteration of the first parallel stage of the parallel pipeline and a fourth instance of the ISC for a fourth stage iteration of a second parallel stage of the parallel pipeline, and
wherein the stored processor-executable instructions are configured to cause the processor to perform operations further comprising relinquishing an execution control edge from at least one of the third stage iteration and the fourth stage iteration depending on the first instance of the ISC in response to determining that the first stage iteration is complete.

27. The non-transitory processor-readable storage medium of claim 25, wherein the plurality of instances of the ISC includes a third instance of the ISC for a third stage iteration of the first parallel stage of the parallel pipeline, and
wherein the stored processor-executable instructions are configured to cause the processor to perform operations further comprising:
determining whether an execution control value is specified for the first stage iteration; and
adding a first execution control edge for the third stage iteration depending on the first instance of the ISC in response to determining that an execution control value is specified for the first stage iteration.

28. The non-transitory processor-readable storage medium of claim 27, wherein the stored processor-executable instructions are configured to cause the processor to perform operations such that determining whether an execution control value is specified for the first stage iteration comprises determining whether a degree of concurrency value is specified for the first parallel stage, wherein the third stage iteration is a number of stage iterations lower in the first parallel stage than the first stage iteration, and wherein the number is derived from the degree of concurrency value.

29. The non-transitory processor-readable storage medium of claim 25, wherein the plurality of instances of the ISC includes a third instance of the ISC for a third stage iteration of a second parallel stage of the parallel pipeline, and
wherein the stored processor-executable instructions are configured to cause the processor to perform operations further comprising:
determining whether an execution control value is specified for the first stage iteration; and
adding a first execution control edge for the third stage iteration depending on the first instance of the ISC in response to determining that an execution control value is specified for the first stage iteration.

30. The non-transitory processor-readable storage medium of claim 29, wherein:
the second parallel stage succeeds the first parallel stage; and
the stored processor-executable instructions are configured to cause the processor to perform operations such that determining whether an execution control value is specified for the first stage iteration comprises determining whether an iteration lag value is specified for between the first parallel stage and the second parallel stage, wherein the third stage iteration is a number of stage iterations higher in the second parallel stage than the first stage iteration in the first parallel stage, and wherein the number is derived from the iteration lag value.
